(19) United States
(12) Patent Application Publication
(10) Pub. No.: US 2026/0309487 A1
(43) Pub. Date: Oct. 8, 2026

(54) ANGLE CALCULATION DEVICE AND ANGLE CALCULATION METHOD

(71) Applicant: SONY SEMICONDUCTOR SOLUTIONS CORPORATION, KANAGAWA (JP)

(72) Inventors: TAKUYA ICHIHARA, KANAGAWA (JP); TAKAYUKI HIRABAYASHI, KANAGAWA (JP); UICHIRO OMAE, KANAGAWA (JP); HIROAKI NAKANO, KANAGAWA (JP)

(21) Appl. No.: 19/482,790

(22) PCT Filed: May 13, 2024
(86) PCT No.: PCT/JP2024/017564

§ 371 Date: Nov. 10, 2025

(30) Foreign Application Priority Data
May 22, 2023 (JP) 2023-084005

(51) Int. Cl. G01B 15/00; G01B 21/22; G01S 13/44

(52) U.S. Cl. CPC G01B 15/00; G01B 21/22; G01S 13/4454

(57) ABSTRACT

An angle calculation device according to the present technology includes an angle calculator that calculates, based on receipt signals of each of two or more first antennae and a second antenna, an angle of arrival of a radio wave at the first antennae from the second antenna. The first antennae are disposed in a first device at a spacing of a 0.25 wavelength or less of a carrier wave. The second antenna is disposed in a second device different from the first device. The receipt signals are obtained by performing round-trip communication for phase-based ranging between the first antennae and the second antenna.

### TECHNICAL FIELD

The present technology relates to a technical field of an angle calculation device and its method to calculate an angle of arrival of a radio wave based on a phase difference between receipt signals of a plurality of antennae.

### BACKGROUND ART

In recent years, indoor mapping techniques have attracted attention. Studies have been made for ranging methods for mapping by radio signals, e.g., BLE (Bluetooth Low Energy: Bluetooth is a registered trademark) and UWB (Ultra Wide Band), with advancement of their standardization. There are roughly two methods of mapping: a method of identifying a position based on distance information with respect to a plurality of base stations (beacons); and a method of identifying a position based on distance information with respect to a single base station and direction information.

As a method of detecting a direction of a base station, there is a method of detecting a phase difference in receipt signals or transmission signals by a plurality of antennae and detecting an angle of arrival (Angle of Arrival: AoA) or an angle of departure (Angle of Departure: AoD) of a radio wave based on the phase difference.

Patent Literature 1 below discloses a technique in which a distance and an angle of arrival are calculated using time response information obtained from receipt signals of a plurality of antennae, and a position is estimated based on the distance and the angle of arrival.

### CITATION LIST

### Patent Literature

Patent Literature 1: Japanese Unexamined Patent Application Publication No. 2021-100169

### SUMMARY OF THE INVENTION

### Problem to be Solved by the Invention

However, the currently-available direction detection techniques to detect the angle of arrival and the angle of departure described above have had an issue of a significant decline in direction detection accuracy due to influences of multipath. Specifically, in a case where an obstacle is present between an antenna on transmitter side and an antenna on receiver side, a situation may occur in which an advancing wave propagated by a linear path to the antenna on the receiver side is attenuated by influences of shielding or the like, and a delayed wave that is reflected from a wall or the like and propagated becomes stronger. In this case, the angle of arrival and the angle of departure are calculated with respect to the delayed wave, resulting in erroneous direction detection.

The present technology has been made in view of such circumstances, and its object is to attain enhanced detection accuracy of an angle of arrival of a radio wave.

### Means for Solving the Problem

An angle calculation device according to the present technology includes: an angle calculator that calculates, based on receipt signals of each of two or more first antennae and a second antenna, an angle of arrival of a radio wave at the first antennae from the second antenna. The first antennae are disposed in a first device at a spacing of a 0.25 wavelength or less of a carrier wave. The second antenna is disposed in a second device different from the first device. The receipt signals are obtained by performing round-trip communication for phase-based ranging between the first antennae and the second antenna.

As described above, by adopting a method of calculating the angle of arrival of the radio wave based on the receipt signals obtained by performing the round-trip communication for the phase-based ranging, enhanced angle detection accuracy is attained as compared with a case of calculating the angle of arrival and the angle of departure based on receipt signals by one-way communication as has been currently-available. On this occasion, to address an issue of a grating lobe in the case of performing the round-trip communication, the spacing between the two or more first antennae is set to the 0.25 wavelength or less of the carrier wave.

### BRIEF DESCRIPTION OF DRAWINGS

FIG. 1 is a block diagram illustrating a configuration example of a mapping system including an angle calculation device according to an embodiment of the present technology.

FIG. 2 is a block diagram illustrating a hardware configuration example (internal configuration example) of the angle calculation device according to the embodiment.

FIG. 3 is a block diagram illustrating an internal configuration example of a wireless communication module included in the angle calculation device according to the embodiment.

FIG. 4 is a block diagram illustrating an internal configuration example of a communication device according to the embodiment.

FIG. 5 is diagrams illustrating example modes of phase measurement in a phase-based method.

FIG. 6 is an illustrative diagram of a phase of a signal propagation path to be measured in the phase-based method.

FIG. 7 is illustrative diagrams of a phase characteristic of the signal propagation path with respect to a frequency.

FIG. 8 is an illustrative diagram of a currently-available method of calculating an angle of arrival of a radio wave.

FIG. 9 is an illustrative diagram of influences of multipath.

FIG. 10 is illustrative diagrams of a time waveform signal of the phase.

FIG. 11 is a flowchart illustrating an example of a detailed processing procedure to realize an angle detection method according to a first embodiment.

FIG. 12 is a flowchart illustrating, together with FIG. 11, an example of the detailed processing procedure to realize the angle detection method according to the first embodiment.

FIG. 13 is an illustrative diagram of an issue of a grating lobe.

FIG. 14 is a diagram illustrating relation between an antenna spacing and a detectable angle.

FIG. 15 is a diagram to illustrate a spacing between first antennae in the embodiment.

FIG. 16 is a diagram illustrating a simulation result of a change characteristic of a phase difference in a case with setting to an antenna spacing according to the embodiment.

FIG. 17 is illustrative characteristic diagrams related to presence or absence of 50Ω-termination.

FIG. 18 is diagrams illustrating performance evaluation results of the angle detection method according to the first embodiment.

FIG. 19 is a block diagram illustrating an internal configuration example of a wireless communication module included in an angle calculation device according to a second embodiment.

FIG. 20 is illustrative diagrams of a method of identifying an amplitude of an advancing wave from a time waveform signal of an amplitude.

FIG. 21 is a flowchart illustrating an example of a detailed processing procedure to realize an angle detection method according to the second embodiment.

FIG. 22 is diagrams illustrating specific combination examples as to which device an angle calculator and a plurality of antennae are to be included in.

FIG. 23 is an illustrative diagram of an example a third device includes the angle calculator.

### MODES FOR CARRYING OUT THE INVENTION

In the following, embodiments of the present technology are described in the following order with reference to the accompanied drawings.
<1. First Embodiment>
<1-1. Configuration Example of Mapping System>
<1-2. Internal Configuration Example of Information Processing Device>
<1-3. Internal Configuration Example of Communication Device>
<1-4. Ranging and Mapping by Phase-Based Method>
<1-5. Angle Detection Method According to First Embodiment>
<1-6. Processing Procedure>
<1-7. Antenna Spacing and Effects>
<2. Second Embodiment>
<3. Modification Examples>
<4. Summary of Embodiments>
<5. The Present Technology>

### 1. First Embodiment

### 1-1. Configuration Example of Mapping System

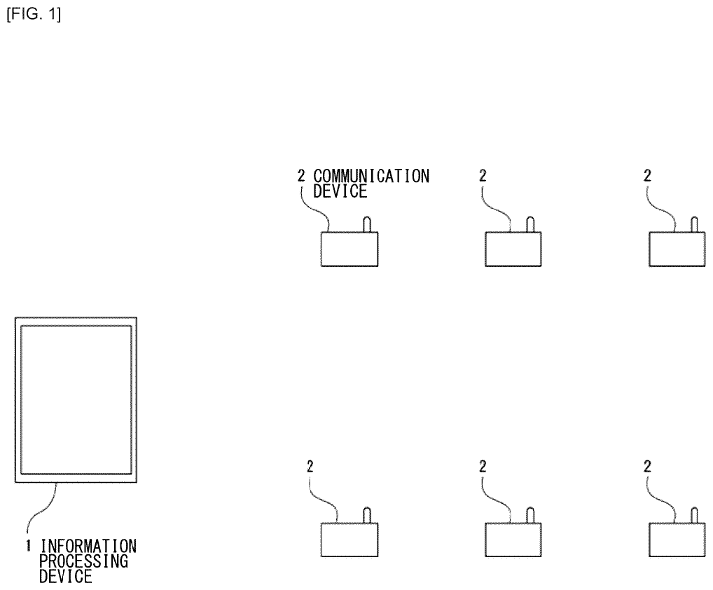

FIG. 1 is a block diagram illustrating a configuration example of a mapping system including an information processing device 1 according to an embodiment of an angle calculation device according to the present technology.

As illustrated in the figure, the mapping system includes the information processing device 1 and a plurality of communication devices 2 configured to perform wireless communication with the information processing device 1.

The information processing device 1 includes a computer device including a microcomputer including a CPU (Central Processing Unit), a ROM (Read Only Memory), and a RAM (Random Access Memory). In this example, the information processing device 1 is assumed to be a smartphone, but the information processing device 1 may be any other computer device such as a tablet terminal or a personal computer (e.g., a notebook type).

In the present embodiment, the information processing device 1 and the communication device 2 are configured to perform the wireless communication as short-range wireless communication between them. Specifically, in this example, the information processing device 1 and the communication device 2 are configured to perform the wireless communication by the BLE (Bluetooth Low Energy: Bluetooth is a registered trademark). In this case, the communication device 2 includes a device that serves as a BLE beacon.

In the first embodiment, the information processing device 1 performs the wireless communication by the BLE with the plurality of the communication devices 2, performs ranging by a phase-based method with the plurality of the communication devices 2, and makes calculation of an angle of arrival of a radio wave. Moreover, using ranging results obtained for each of the communication devices 2 and information regarding the angle of arrival, the information processing device 1 performs mapping as to a position of itself.

Here, to realize the mapping based on the angle of arrival and a distance, it suffices that the information processing device 1 performs the ranging and the calculation of the angle of arrival with respect to one communication device 2. By performing the mapping based on the results of the ranging and the calculation of the angle of arrival with respect to the plurality of the communication devices 2 as described above, it is possible to attain enhanced mapping accuracy of the position of itself by, for example, averaging the positions of itself calculated based on the distance and the angle of arrival for each communication device 2.

It is to be noted that the ranging by the phase-based method and a specific method of the calculation of the angle of arrival according to the embodiment are described later.

### 1-2. Internal Configuration Example of Information Processing Device

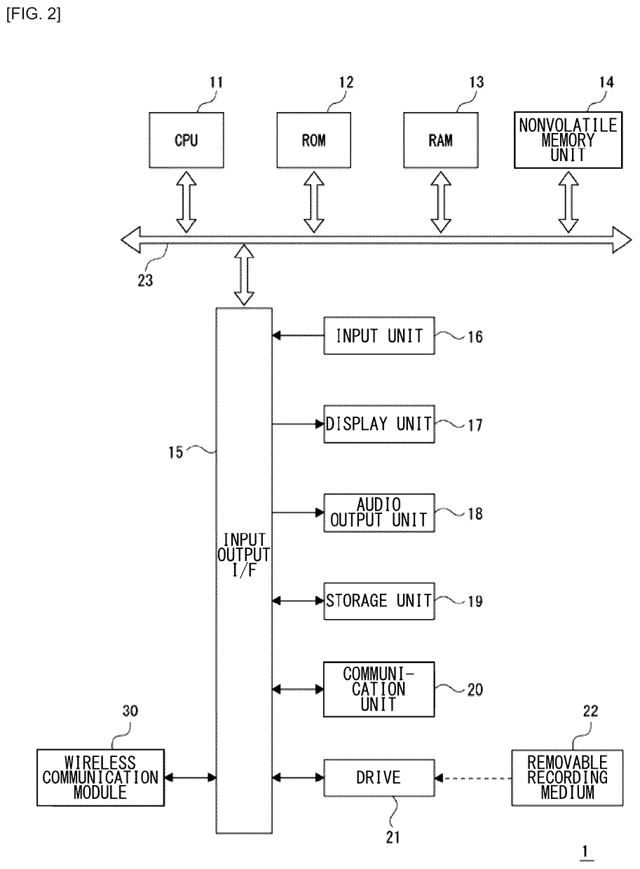

FIG. 2 is a block diagram illustrating a hardware configuration example of the information processing device 1.

As illustrated in the figure, the information processing device 1 includes a CPU 11. The CPU 11 performs various kinds of processing in accordance with a program held in a ROM 12 or, for example, a nonvolatile memory unit 14 such as an EEP-ROM (Electrically Erasable Programmable Read-Only Memory), or a program loaded into a RAM 13 from a storage unit 19. The RAM 13 also holds, as appropriate, data necessary for the CPU 11 to perform the various kinds of processing.

The program as used here may include an application program to realize the mapping based on the ranging results by the phase-based method and the results of the calculation of the angle of arrival, and an application program to realize various functions using mapping results such as a navigation function.

The CPU 11, the ROM 12, the RAM 13, and the nonvolatile memory unit 14 are coupled to each other through a bus 23. To the bus 23, an input/output interface (I/F) 15 is also coupled.

To the input/output interface 15, an input unit 16 is coupled. The input unit 16 includes an operator and an operation device. For example, the input unit 16 is assumed to include various operators and operating devices, e.g., a keyboard, a mouse, a key, a dial, a touchscreen, a touch pad, and a remote controller.

An operation is detected by the input unit 16, and a signal corresponding to the detected operation is interpreted by the CPU 11.

Moreover, to the input/output interface 15, a display unit 17 and an audio output unit 18 are integrally or separately coupled. The display unit 17 includes an LCD (Liquid Crystal Display), an organic EL (Electro-Luminescence) panel, or the like. The audio output unit 18 includes a speaker or the like.

The display unit 17 is used for various kinds of information display. The display unit 17 includes, for example, a display device provided in a housing of the information processing device 1, a separate display device coupled to the information processing device 1, and the like.

The display unit 17 provides display of images for various kinds of image processing, moving images to be processed, and the like, on a display screen, based on an instruction by the CPU 11. Moreover, the display unit 17 provides display of various operating menus, icons, messages, and the like, based on an instruction from the CPU 11. That is, the display unit 17 provides display as a GUI (Graphical User Interface).

To the input/output interface 15, the storage unit 19 and a communication unit 20 are sometimes coupled. The storage unit 19 includes an HDD (Hard Disk Drive), a solid-state memory, or the like. The communication unit 20 includes a modem or the like.

The communication unit 20 performs communication with an external device through a network line such as the Internet.

To the input/output interface 15, a drive 21 is also coupled as necessary. To the drive 21, a removable recording medium 22 such as a magnetic disk, an optical disk, a magneto-optical disk, or a semiconductor memory is attached as appropriate.

The drive 21 helps read out a data file or the like, e.g., a program to be used in each process from the removable recording medium 22. The data file read out is held in the storage unit 19, and images and sounds included in the data file are outputted by the display unit 17 and the audio output unit 18. Moreover, the computer program or the like read out from the removable recording medium 22 is installed in the storage unit 19 as necessary.

Moreover, to the input/output interface 15, a wireless communication module 30 is coupled.

The wireless communication module 30 is a communication module to perform the short-range wireless communication with an external device. Specifically, in this example, the wireless communication module 30 is configured to perform the wireless communication by the BLE with the communication device 2.

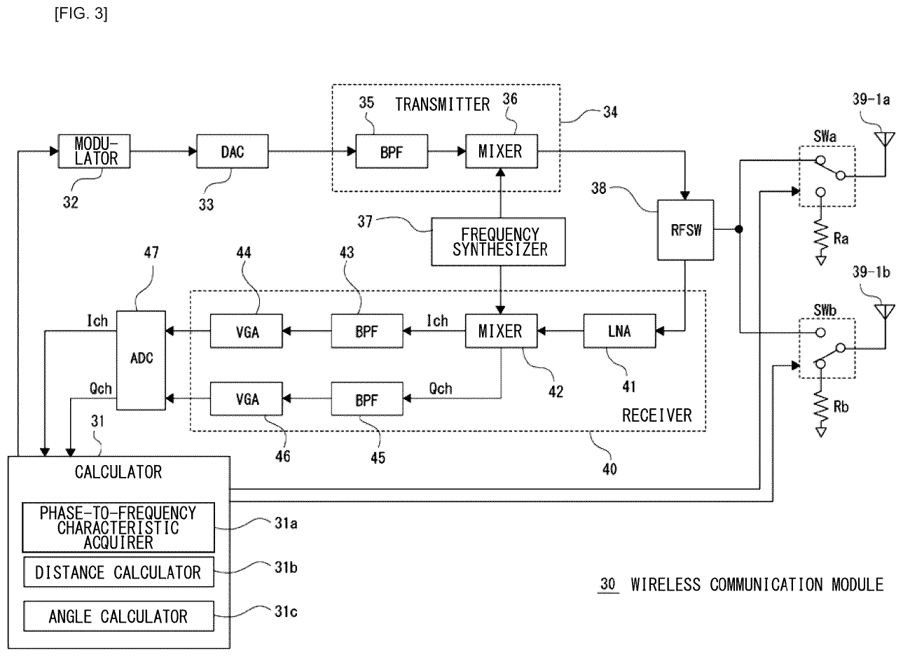

FIG. 3 is a block diagram illustrating an internal configuration example of the wireless communication module 30.

As illustrated in the figure, the wireless communication module 30 includes a calculator 31, a modulator 32, a DAC (Digital to Analog Converter) 33, a transmitter 34, a frequency synthesizer 37, a RF switch (SW) 38, a plurality of first antennae 39-1, a plurality of switches SW, a plurality of resistors R, a receiver 40, and an ADC (Analog to Digital Converter) 47.

The switches SW and the resistors R are provided for the respective first antennae 39-1. In this example, an example is given where a first antenna 39-1a and a first antenna 39-1b are provided as the two first antennae 39-1. Accordingly, a switch SWa and a switch SWb are provided as the two switches SW, and a resistor Ra and a resistor Rb are provided as the two resistors R.

As described above, the wireless communication module 30 in this example is configured to perform the wireless communication by the BLE. In the BLE, it is possible to shorten, as much as possible, time it takes to perform operation that necessitates a large amount of electric power, e.g., establishing coupling or data communication. This leads to suppression of power consumption, and downsizing of the wireless communication module 30.

The modulator 32 performs modulation processing of a signal to perform the wireless communication with the communication device 2. Here, for example, IQ modulation is performed as the modulation processing. In the IQ modulation, as a baseband signal, an I-channel (In-phase: in-phase component) signal and a Q-channel (Quadrature: quadrature component) signal are used.

The modulator 32 performs the modulation processing as the IQ modulation on data to be transmitted. The data to be transmitted is supplied from the calculator 31.

The DAC 33 converts a digital signal from the modulator 32 into an analog signal. The analogue signal converted by the DAC 33 is supplied to the transmitter 34.

The transmitter 34 is a block that transmits a signal by the wireless communication. As illustrated in the figure, the transmitter 34 includes a BPF (Band Pass Filter) 35 and a mixer 36. The BPF 35 passes only signals of a specific frequency band. That is, the BPF 35 supplies only the signals of the specific frequency band to the mixer 36 with respect to the analog signal from the DAC 33.

The mixer 36 mixes a local oscillation frequency supplied from the frequency synthesizer 37 with the signal supplied from the BPF 35, and thereby performs conversion into a transmission frequency of the wireless communication.

The frequency synthesizer 37 supplies a frequency to be used in transmission and receipt. Specifically, the frequency synthesizer 37 includes a local oscillator in its inside, and is used in conversion of a radio frequency signal and the baseband signal of the wireless communication.

The RF switch 38 is a switch that switches the radio frequency (RF: Radio Frequency) signal. On the occasion of the transmission, the RF switch 38 couples the transmitter 34 to the first antenna 39-1a or the first antenna 39-1b. On the occasion of the receipt, the RF switch 38 couples the receiver 40 to the first antenna 39-1a or the first antenna 39-1b. Each of the first antennae 39-1 is an antenna to perform signal transmission and receipt by the wireless communication.

In this example, as each of the first antennae 39-1, a patch antenna is used. Specifically, for example, a ceramic patch antenna is used.

Here, the switch SWa is configured to make a switchover between a state in which the first antenna 39-1a is coupled to the RF switch 38 and a state in which the first antenna 39-1a is coupled to the resistor Ra. The switch SWb is configured to make a switchover between a state in which the first antenna 39-1b is coupled to the RF switch 38 and a state in which the first antenna 39-1b is coupled to the resistor Rb.

As is described later, in the state where the first antenna 39-1a is coupled to the RF switch 38 by the switch SWa, the first antenna 39-1b is coupled to the resistor Rb by the switch SWb, and the first antenna 39-1b is not coupled to the RF switch 38. Meanwhile, in the state where the first antenna 39-1b is coupled to the RF switch 38 by the switch SWb, the first antenna 39-1a is coupled to the resistor Ra by the switch SWa, and the first antenna 39-1a is not coupled to the RF switch 38.

It is to be noted that the significance of providing the switches SWa and SWb, the resistors Ra, and the resistor Rb is described later.

The receiver 40 is a block that receives signals by the wireless communication. As illustrated in the figure, the receiver 40 includes an LNA (Low Noise Amplifier) 41, a mixer 42, a BPF 43, a VGA (Variable Gain Amplifier) 44, a BPF 45, and a VGA 46.

The LNA 41 amplifies the RF signal received by the first antenna 39-1 (39-1a or 39-1b). The mixer 42 mixes the local oscillation frequency supplied from the frequency synthesizer 37, with the signal supplied from the LNA 41, to obtain each of the I-channel signal and the Q-channel signal. The I-channel signal (expressed by “Ich” in the figure) is supplied to the BPF 43, and the Q-channel signal (expressed by “Qch” in the figure) is supplied to the BPF 45.

The I-channel signal obtained by the mixer 42 is inputted to the BPF 43, and only a signal of a specific frequency band is extracted and supplied to the VGA 44. Meanwhile, the Q-channel signal obtained by the mixer 42 is inputted to the BPF 45, and only a signal of a specific frequency band is extracted and supplied to the VGA 46.

The VGA 44 and the VGA 46 serve as analog variable gain amplifiers that adjust gains with respect to the I-channel signal supplied from the BPF 43 and the Q-channel signal supplied from the BPF 45, respectively.

The ADC 47 converts the I-channel and Q-channel signals from the receiver 40, that is, the I-channel and Q-channel signals outputted through the VGA 44 and the VGA 46, from analog signals to digital signals.

The I-channel and Q-channel signals converted into the digital signals are supplied to the calculator 31.

The calculator 31 includes a microcomputer including, for example, a CPU (Central Processing Unit), a ROM (Read Only Memory), and a RAM (Random Access Memory). The CPU performs various kinds of processing in accordance with, for example, a program held in the ROM or a program loaded to the RAM from the ROM.

For example, the calculator 31 performs processing to supply the modulator 32 with data to be transmitted, and allow the modulator 32 to modulate the data. Moreover, the calculator 31 also performs processing, for example, to demodulate received data based on data regarding the I-channel and Q-channel signals supplied from the ADC 47.

Moreover, in particular, the calculator 31 has a function as a phase-to-frequency characteristic acquirer 31a and a distance calculator 31b illustrated in the figure, as a function of performing ranging using the wireless communication.

The phase-to-frequency characteristic acquirer 31a acquires a phase characteristic with respect to a frequency of a signal propagation path to the communication device 2. In this example, the phase-to-frequency characteristic acquirer 31a performs processing to acquire the phase characteristic with respect to the frequency of the signal propagation path, to perform the ranging by the phase-based method, as the ranging using the wireless communication,

The distance calculator 31b calculates the distance to the communication device 2 based on the phase characteristic of the signal propagation path with respect to the frequency acquired by the phase-to-frequency characteristic acquirer 31a.

Furthermore, the calculator 31 in the present embodiment also has a function as an angle calculator 31c that calculates the angle of arrival of the radio wave at the first antennae 39-1 from the second antenna (second antenna 39-2 described later) included in the communication device 2, based on receipt signals obtained as a result of performing, for each first antenna 39-1, the round-trip communication for the ranging by the phase-based method with the communication device 2.

It is to be noted that the angle calculator 31c is described later.

### 1-3. Internal Configuration Example of Communication Device

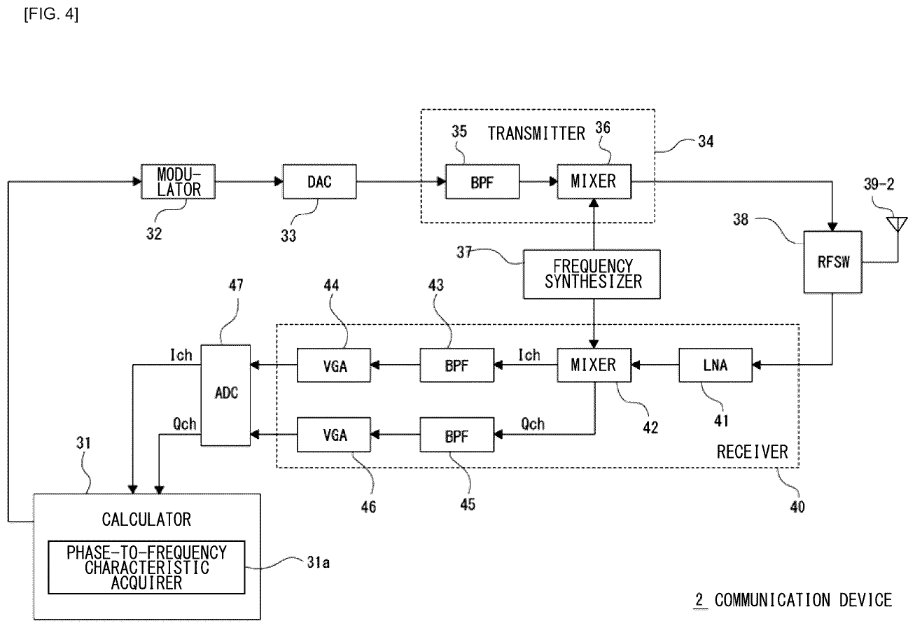

FIG. 4 is a block diagram illustrating an internal configuration example of the communication device 2.

As can be seen in comparison with FIG. 3, the internal configuration of the communication device 2 is similar to the internal configuration of the wireless communication module 30 except that only one second antenna 39-2 is coupled to the RF switch 38 as an antenna for the wireless communication, and that the calculator 31 includes only the phase-to-frequency characteristic acquirer 31a out of the phase-to-frequency characteristic acquirer 31a, the distance calculator 31b, and the angle calculator 31c. Thus, redundant description is avoided.

### 1-4. Ranging and Mapping by Phase-Based Method

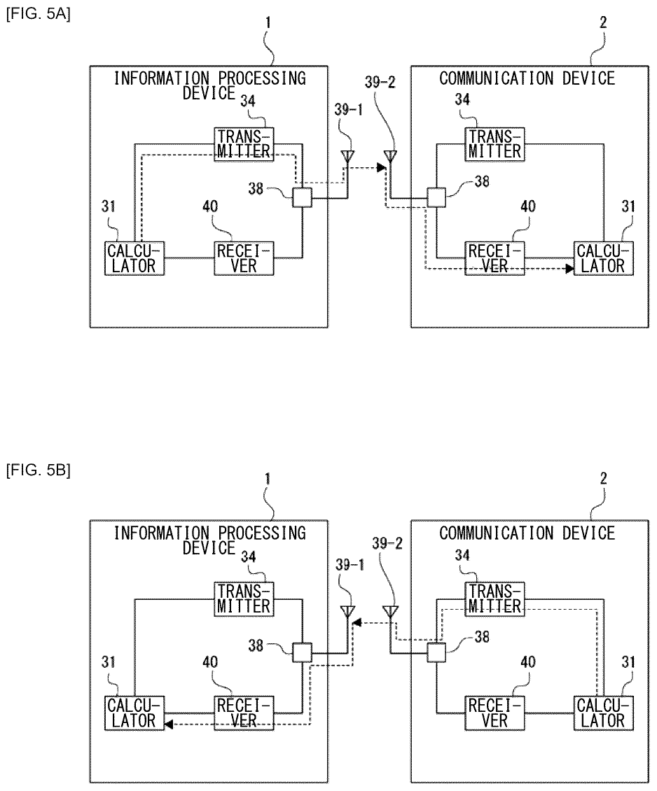

FIG. 5 is a diagram illustrating example modes of phase measurement in the phase-based method. In the phase-based method, the phase is measured based on a result of the wireless communication while changing the frequency, between two devices having a wireless communication function, that is, between the information processing device 1 (wireless communication module 30) and the communication device 2 in this example.

At this occasion, first, as illustrated in FIG. 5A, the information processing device 1 (initiator) transmits a measurement signal toward the communication device 2 (reflector). As used herein, the initiator means a device that performs distance calculation processing based on the measured phase, and the reflector means a device that is paired with an initiator and exchanges the measurement signal with the initiator.

It is to be noted that FIG. 5 mainly illustrates a flow of the measurement signal related to the phase measurement, and the illustration of, for example, the modulator 32, the DAC 33, the frequency synthesizer 37, and the ADC 47 is omitted. Moreover, as to the antenna as the information processing device 1 and parties concerned, only one first antenna 39-1 is illustrated for convenience of the description.

In FIG. 5A, in the information processing device 1 as the initiator, the measurement signal is transmitted from the first antenna 39-1 through the transmitter 34 from the calculator 31. Moreover, in the communication device 2 as the reflector, the measurement signal is received by the receiver 40 through the second antenna 39-2.

Thus, as illustrated in FIG. 5B, the measurement signal is returned from the communication device 2 toward the information processing device 1. That is, in the communication device 2, the measurement signal is transmitted from the second antenna 39-2 through the transmitter 34 from the calculator 31, while in the information processing device 1, the measurement signal is received by the receiver 40 through the first antenna 39-1, and in the calculator 31, the phase characteristic between them is measured. By performing the round-trip communication in this way, it is possible to appropriately measure the phase characteristic between the two devices.

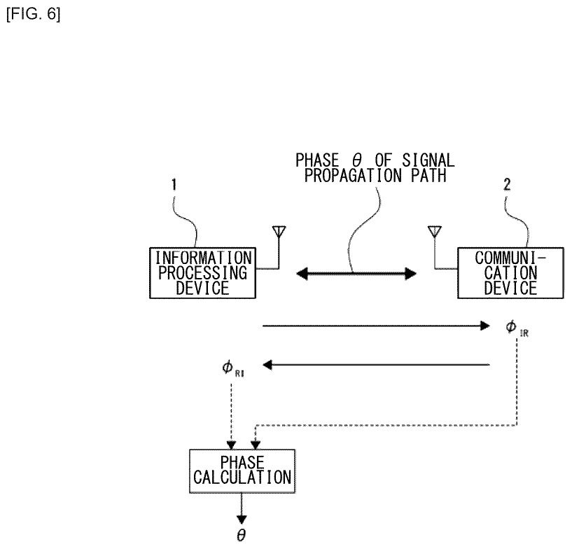

FIG. 6 is an illustrative diagram of a phase θ of the signal propagation path to be measured in the phase-based method.

As illustrated in FIG. 5A, when the measurement signal is transmitted from the information processing device 1 and the parties concerned, to the communication device 2 and parties concerned, a signal phase φ of the measurement signal is measured in the communication device 2. Here, the signal phase φ to be measured when the measurement signal is transmitted from the information processing device 1 and the parties concerned (initiator) to the communication device 2 and the parties concerned (reflector) as described above is expressed by “φ_{IR}.”

Moreover, as illustrated in FIG. 5B, when the measurement signal is transmitted from the communication device 2 and the parties concerned, to the information processing device 1 and the parties concerned, the signal phase φ of the measurement signal is measured in the information processing device 1. The signal phase φ to be measured when the measurement signal is transmitted from the communication device 2 and the parties concerned, to the information processing device 1 and the parties concerned as described above is expressed by “φ_{RI}”.

Here, the signal phase φ is given by the following [Expression 1] when the I channel and Q channel signals obtained by the receipt of the measurement signal are denoted by “I” and “Q,” respectively.

$$[ Mathematical Expression 1 ]$$

$$φ = {tan}^{- 1} ( Q / I ) \qquad [ Expression 1 ]$$

Thus, in the phase-based method, the phase θ of the signal propagation path is obtained based on the signal phase PIR and the signal phase φ_{RI} described above. Specifically, the phase θ of the signal propagation path is calculated as a phase 2θ for the round-trip of the signal propagation path, by adding together the signal phase φ_{IR} and the signal phase φ_{RI}. In a possible alternative, the phase θ of the signal propagation path may be directly obtained by obtaining an average value of the signal phase PIR and the signal phase (RI.

In the phase-based method, the measurement of the phase θ as described above is performed for each frequency while sequentially changing a frequency of the measurement signal within a predetermined frequency band. In other words, the phase θ is measured for a plurality of frequencies. It is to be noted that the “predetermined frequency band” as used here may be possibly assumed as a frequency band determined as a usage band in accordance with a communication standard, e.g., a 2.4 GHz band (band from 2400 MHz to 2480 MHz) for the BLE.

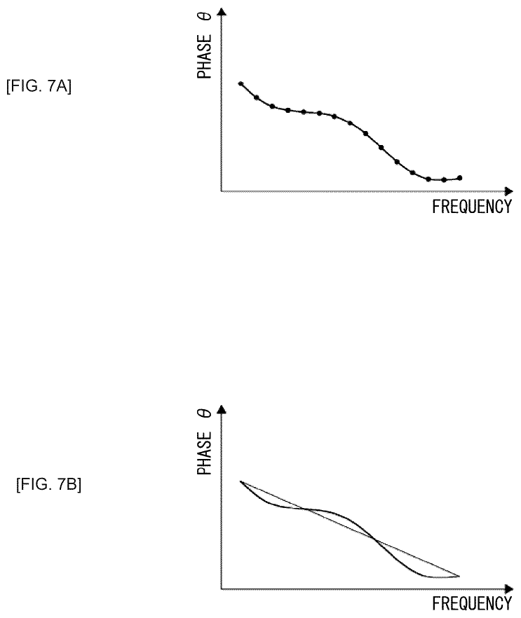

When the phase θ is measured for each frequency within the predetermined frequency band as described above, measurement results as illustrated in FIG. 7A are obtained. The black circles in the figure represent the measurement results of the phase θ at the respective frequencies.

The results illustrated in FIG. 7A can be referred to as the phase characteristic of the signal propagation path with respect to the frequency.

In the phase-based method, the ranging is performed based on how the phase θ changes when the frequency changes. Specifically, in the characteristic of the phase θ with respect to the change in the frequency, magnitude of a slope of the phase θ as illustrated in FIG. 7B correlates with magnitude of the distance. At this occasion, an increase in steepness of the slope of the phase θ indicates an increase in the distance. Accordingly, it is possible to calculate the distance based on the slope of the phase θ.

As a specific method of calculating the distance, the following method may be given as an example: obtaining a group delay τ from the slope of the phase θ; and multiplying the group delay r by the speed of light (=299792458 m/s). A reason for the use of the group delay τ is to eliminate influences of 2π uncertainty of the phase. It is to be noted that the group delay τ is obtained by differentiating the phase θ by an angular frequency ω.

Similarly, as a method of calculating the distance from the phase 2θ for the round-trip of the signal propagation path, the following method may be given as an example: obtaining a group delay 2τ from a slope of the phase 2θ; multiplying the group delay 2τ by the speed of light; and further multiplying the resultant value by ½.

Here, the calculation method of the distance based on the “characteristic of the phase θ with respect to the frequency,” i.e., the “phase characteristic of the signal propagation path with respect to the frequency” is not limited to the methods described above. There are various possible methods. For example, it is conceivable to adopt a method including: acquiring not only the characteristic of the phase θ with respect to the frequency but also a characteristic of an amplitude A with respect to the frequency, that is, acquiring not only the frequency characteristic of the phase θ but also a frequency characteristic of the amplitude A; converting the frequency characteristics of the phase θ and the amplitude A into time-response waveforms by an inverse Fourier transform such as an IFFT (Inverse Fast Fourier Transform); and obtaining the distance based on the time-response waveforms.

Here, the amplitude A can be obtained as an amplitude A² for the round-trip of the signal propagation path by multiplying a signal amplitude a_{IR} by a signal amplitude a_{RI} obtained for each frequency by performing the round-trip communication for the phase-based ranging. In another possible alternative, the amplitude A of the signal propagation path may be directly obtained by, for example, obtaining an average value of the signal amplitude a_{IR} and the signal amplitude a_{RI}.

Here, a signal amplitude a can be given by the following [Expression 2].

$$[ Mathematical Expression 2 ]$$

$$a = \sqrt{( {I}^{2} + {Q}^{2} )} \qquad [ Expression 2 ]$$

That is, it is possible to obtain the amplitude a as a square root of (I²+Q²).

Here, in the following description, the ranging by the phase-based method described above may be sometimes referred to as “phase-based ranging.”

Moreover, in the following, with respect to the phase-based ranging, the round-trip communication between the initiator and the reflector as described above is referred to as the “round-trip communication for the phase-based ranging.” This “round-trip communication for the phase-based ranging” means communication processing to obtain the characteristic of the phase θ with respect to the frequency, that is, the phase characteristic of the signal propagation path with respect to the frequency. Specifically, the “round-trip communication for the phase-based ranging” means processing to mutually transmit and receive a plurality of the measurement signals having different frequencies between the initiator and the reflector.

### 1-5. Angle Detection Method According to First Embodiment

In the present embodiment, as the calculation method of the angle of arrival of the radio wave, a method in accordance with a currently-available calculation method of the angle of arrival and the angle of departure is adopted.

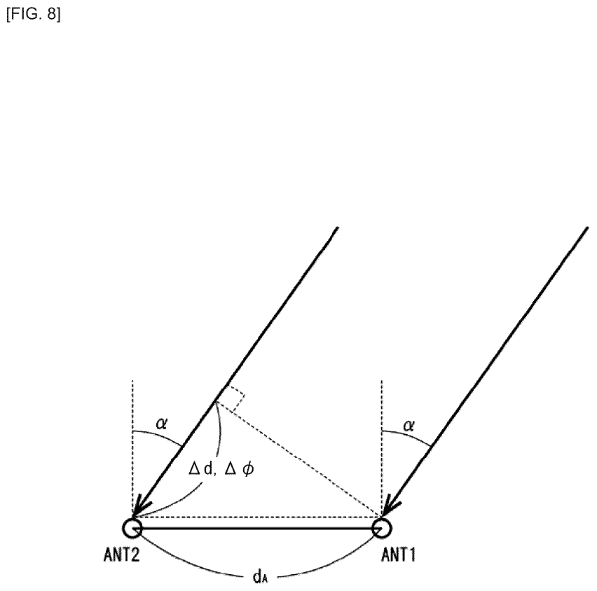

For the purpose of confirmation, with reference to FIG. 8, the currently-available calculation method of the angle of arrival of the radio wave is described.

In the figure, the two first antennae 39-1 are denoted by “ANT1” and “ANT2.” The figure schematically illustrates a case where the radio wave from the second antenna 39-2 enter the two first antennae 39-1 denoted by “ANT1” and “ANT2” at an angle α inclined toward “ANT1.”

As illustrated in the figure, when the radio wave from the second antenna 39-2 enter at the angle α, travel distances of the radio wave have a difference by an amount “Δd” illustrated in the figure. Specifically, in the example illustrated in the figure, the travel distance on “ANT2” side is longer than the travel distance on “ANT1” side by the amount “Δd.”

When the difference “Δd” in the distance is obtained, the angle α can be obtained by geometric calculation (trigonometric function) using a distance (antenna spacing) “d_{A}” between the two first antennae 39-1.

Here, the difference “Δd” in the distance can be estimated by a phase difference Δφ between the receipt signals of the two first antennae 39-1 denoted by “ANT1” and “ANT2.” Accordingly, obtaining the phase difference Δφ makes it possible to calculate the angle α using the distance d_{A} between the antennae as a known value. Specifically, the angle α is given by the following [Expression 3].

$$[ Mathematical Expression 3 ]$$

$$α = {sin}^{- 1} ( c Δ φ / ω {d}_{A} ) \qquad [ Expression 3 ]$$

In [Expression 3], “c” means the speed of light and “ω” means the angular frequency of a carrier wave.

It is to be noted that, in the forgoing, a method of obtaining the angle of arrival (AoA) (that is, a method of using a plurality of antennae on the receiver side) is given as an example. Meanwhile, a method of obtaining the angle of departure (AoD) is similar to the forgoing except that a plurality of antennae is provided on the transmission side, and therefore, redundant description is avoided.

Moreover, for the purpose of confirmation, the currently-available method of obtaining the angle of arrival and the angle of departure does not include performing the round-trip communication while changing the frequency as in the phase-based method described above, but includes calculating the phase difference Δφ and calculating the angle α by [Expression 3] based on receipt signals by one-way communication at a certain frequency.

Here, as described above, the currently-available direction detection techniques to detect the angle of arrival and the angle of departure have the issue of the significant decline in the direction detection accuracy due to the influences of the multipath.

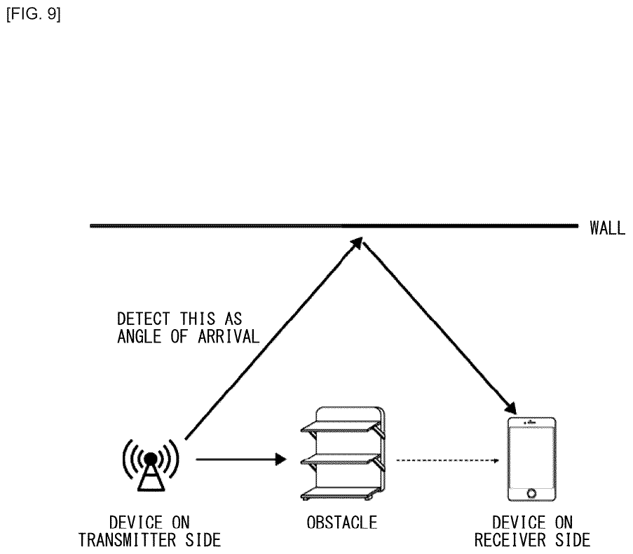

For example, as illustrated in FIG. 9, in a case where an obstacle is present between a device on the transmitter side and a device on the receiver side, a situation may occur in which an advancing wave propagated by a linear path to the device on the receiver side is attenuated by the influences of shielding or the like, and a delayed wave that is reflected from a wall or the like and propagated becomes stronger.

In this case, the angle of arrival and the angle of departure are calculated with respect to the delayed wave, resulting in the erroneous direction detection.

Thus, the present embodiment does not adopt the currently-available direction detection method by the one-way communication, but adopts the method of performing the round-trip communication for the phase-based ranging, as the communication between each of the first antennae 39-1 and the second antenna 39-2, and calculating the angle of arrival of the radio wave at the first antennae 39-1 from the second antenna 39-2 based on the receipt signals obtained by performing the round-trip communication.

Performing the round-trip communication for the phase-based ranging makes it possible to identify the advancing wave in a multipath-generating environment, and attain more enhanced angle detection accuracy than the case where the angle of arrival and the angle of departure are calculated based on the receipt signals by the one-way communication as has been currently-available.

In the following, specific example methods are described.

In this example, the processing to calculate the angle of arrival of the radio wave is performed by the phase-to-frequency characteristic acquirer 31a, the distance calculator 31b, and the angle calculator 31c described above.

First, the phase-to-frequency characteristic acquirer 31a of the information processing device 1 performs processing to realize the round-trip communication for the phase-based ranging using the first antenna 39-1a. Specifically, by controlling the RF switch 38, the switches SWa and SWb, and the frequency synthesizer 37 described above, the phase-to-frequency characteristic acquirer 31a of the information processing device 1 makes a control to allow the measurement signals with different frequencies to be sequentially transmitted through the first antenna 39-1a. It is to be noted that the control of the switches SWa and SWb is described later.

At this occasion, the phase-to-frequency characteristic acquirer 31a as the communication device 2 and the parties concerned calculates the signal phase YIR mentioned above for each frequency based on the measurement signals with the respective frequencies received from the information processing device 1 and the parties concerned, and transmits information regarding the calculated signal phase φ_{IR} to the information processing device 1 and the parties concerned through the second antenna 39-2.

The phase-to-frequency characteristic acquirer 31a of the information processing device 1 receives and acquires, through the first antenna 39-1, the information regarding the signal phase YIR for each frequency thus transmitted.

Moreover, the phase-to-frequency characteristic acquirer 31a as the communication device 2 and the parties concerned performs processing to sequentially transmit the measurement signal for each frequency to the information processing device 1 through the second antenna 39-2, to make it possible to calculate the signal phase φ_{RI} described above.

The phase-to-frequency characteristic acquirer 31a as the information processing device 1 and the parties concerned controls the RF switch 38 and the frequency synthesizer 37 to receive, through the first antenna 39-1a, the measurement signal for each frequency transmitted in this way from the communication device 2 and the parties concerned. Thus, the phase-to-frequency characteristic acquirer 31a as the information processing device 1 and the parties concerned calculates the signal phase φ_{RI} for each frequency based on the received measurement signal for each frequency.

In the following, the signal phases φ_{IR} and φ_{RI} calculated by performing the round-trip communication using the first antenna 39-1a as described above are represented by “φ_{IR}” and “φa_{RI},” respectively.

The phase-to-frequency characteristic acquirer 31a of the information processing device 1 calculates a phase θ′ for each frequency (a characteristic of the phase 2θ for the round-trip of the signal propagation path or a characteristic of the phase θ of the signal propagation path) based on the signal phases φa_{IR} and φa_{RI} for each frequency.

In the following, the phase θ′ obtained by the round-trip communication using the first antenna 39-1a is referred to as a “phase θa.”

Here, in the present embodiment, when calculating the angle of arrival, the phase θ′ mentioned above and the distance D obtained by the phase-based ranging are used.

Thus, the distance calculator 31b obtains the distance D (antenna spacing) by the calculation method described above, based on the phase θa for each frequency calculated by the phase-to-frequency characteristic acquirer 31a as described above. Here, the distance D calculated based on the phase θa for each frequency as described above, that is, the distance D from the first antenna 39-1a to the second antenna 39-2 calculated by the phase-based ranging using the first antenna 39-1a is hereinafter referred to as a “distance Da.”

The present embodiment includes identifying the advancing wave by using the distance D, attaining the calculation of the appropriate angle of arrival using the phase θ′ of the advancing wave.

For that purpose, the angle calculator 31c performs the following processing.

First, the angle calculator 31c assumes a complex transfer function of an amplitude 1. The complex transfer function has the phase θa for each frequency (that is, the frequency characteristic of the phase θa) as a phase component. The angle calculator 31c extracts a phase component of time-axis complex waveform data, to obtain time-axis waveform data. The time-axis complex waveform data is obtained by performing the inverse Fourier transform on the complex transfer function using, for example, the IFFT (Inverse Fast Fourier Transform) or the like. The time-axis waveform data thus obtained using the phase θa for each frequency as described above is referred to as a “time waveform signal Spa.”

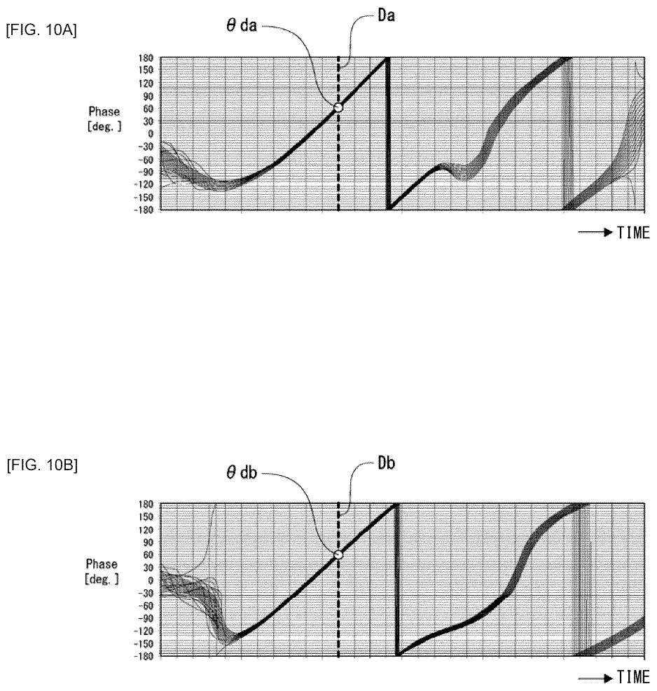

FIG. 10 is an illustrative diagram of a time waveform signal of the phase θ′. FIG. 10A illustrates the time waveform signal Spa.

The distance D correlates with the time it takes for the advancing wave to arrive. Specifically, the arrival time of the advancing wave can be obtained by the distance D/the light speed c. Thus, based on the distance D, the phase θ′ of the advancing wave can be identified from the time waveform signal of the phase θ′.

In the figure, “θda” illustrates the phase θa of the advancing wave identified from the time waveform signal Spa based on the distance Da.

The present embodiment adopts the following method including: obtaining, with respect to each of the first antenna 39-1a and the first antenna 39-1b, the phase θ of the advancing wave identified based on the distance D from the time waveform signal; and calculating the angle of arrival of the radio wave based on a difference value (phase difference) in the phase θ′ of the advancing wave for each antenna.

Thus, in the present embodiment, the processing to obtain the phase θ′ and the distance D is also performed with respect to the first antenna 39-1b similarly to the forgoing.

Specifically, after the phase θda described above is identified, the phase-to-frequency characteristic acquirer 31a of the information processing device 1 performs the processing to realize the round-trip communication for the phase-based ranging using the first antenna 39-1b, and calculates the signal phase φ for each frequency and the phase θ′ for each frequency.

It is to be noted that the processing by the phase-to-frequency characteristic acquirer 31a to acquire the signal phases φ_{IR} and φ_{RI} is similar to the forgoing processing with the use of the first antenna 39-1a except that the first antenna 39-1 to be used in the transmission and the receipt is assumed to be the first antenna 39-1b. Thus, redundant description is avoided.

Here, in the following, the signal phases φ_{IR} and φ_{RI} obtained by performing the round-trip communication for the phase-based ranging using the first antenna 39-1b are referred to as a “signal phase φb_{IR}” and a “signal phase φb_{RI},” respectively. Moreover, the phase θ′ calculated based on the signal phase φb_{IR} and the signal phase φb_{RI} for each frequency is represented by a “phase θb.”

The distance calculator 31b obtains the distance D (antenna spacing) by the calculation method described above based on the phase θb for each frequency calculated by the phase-to-frequency characteristic acquirer 31a. Here, the distance D calculated based on the phase θb for each frequency, that is, the distance D from the first antenna 39-1b to the second antenna 39-2 calculated by the phase-based ranging using the first antenna 39-1b is hereinafter represented by a “distance Db.”

The angle calculator 31c assumes a complex transfer function of an amplitude 1. The complex transfer function has the phase θb for each frequency as a phase component. The angle calculator 31c extracts a phase component of time-axis complex waveform data, to obtain time-axis waveform data. The time-axis complex waveform data is obtained by performing the inverse Fourier transform on the complex transfer function. In the following, the time-axis waveform data thus obtained using the phase θb for each frequency is represented by a “time waveform signal Spb.”

Thus, the angle calculator 31c identifies the phase θb of the advancing wave from the time waveform signal Spb based on the distance Db calculated by the distance calculator 31b. In the following, the phase θb of the advancing wave identified based on the distance Db from the time waveform signal Spb is represented by a “phase θdb.”

FIG. 10B illustrates the phase θdb of the advancing wave identified from the time waveform signal Spb based on the distance Db.

The angle calculator 31c identifies the phase θda and the phase θdb as described above, and thereafter, calculates the difference value between them as a phase difference ΔPh.

Moreover, by substituting the phase difference ΔPh into “Δφ” in [Expression 3] described above, the angle calculator 31c calculates the angle α, that is, the angle of arrival of the radio wave at the first antennae 39-1.

It is to be noted that, in the forgoing, an example is given in which the round-trip communication for the phase-based ranging using the first antenna 39-1a is performed before the round-trip communication for the phase-based ranging using the first antenna 39-1b. However, conversely, the latter round-trip communication may be performed before the former round-trip communication. In another possible alternative, for example, the former round-trip communication and the latter round-trip communication may be alternately performed for each frequency.

As described above, in the present embodiment, the round-trip communication for the phase-based ranging is performed while switching which first antenna 39-1 to use. However, at this occasion, when any first antenna 39-1 that is not in use is in an open state, there is possibility of phase variations in the receipt signal of whichever first antenna 39-1 is in use under influences of re-departure.

Thus, in the present embodiment, the switches SWa and SWb illustrated in FIG. 3 are provided to 50Ω-terminate any first antenna 39-1 other than whichever first antenna 39-1 is in use.

In FIG. 3, the switch SWa is configured to switch a coupling destination of the first antenna 39-1a between the RF switch 38 and the resistor Ra as a 50Ω-resistor. Moreover, the switch SWb is configured to switch a coupling destination of the first antenna 39-1b between the RF switch 38 and the resistor Rb as a 50Ω-resistor.

When the first antenna 39-1a is in use for the round-trip communication for the phase-based ranging, the angle calculator 31c sets the coupling destination of the first antenna 39-1a to the RF switch 38 by controlling the switch SWa, and sets the coupling destination of the first antenna 39-1b to the resistor Rb by controlling the switch SWb.

Meanwhile, when the first antenna 39-1b is in use for the round-trip communication for the phase-based ranging, the angle calculator 31c sets the coupling destination of the first antenna 39-1b to the RF switch 38 by controlling the switch SWb, and sets the coupling destination of the first antenna 39-1a to the resistor Ra by controlling the switch SWa.

This makes it possible to 50Ω-terminate any first antenna 39-1 other than whichever first antenna 39-1 is in use.

Here, as described above, the information processing device 1 has the mapping function for the position of itself.

As mentioned above, when calculating the angle of arrival of the radio wave, the mapping of the position of itself can be performed based on the angle of arrival calculated for at least one of the communication devices 2 and the distance D.

### 1-6. Processing Procedure

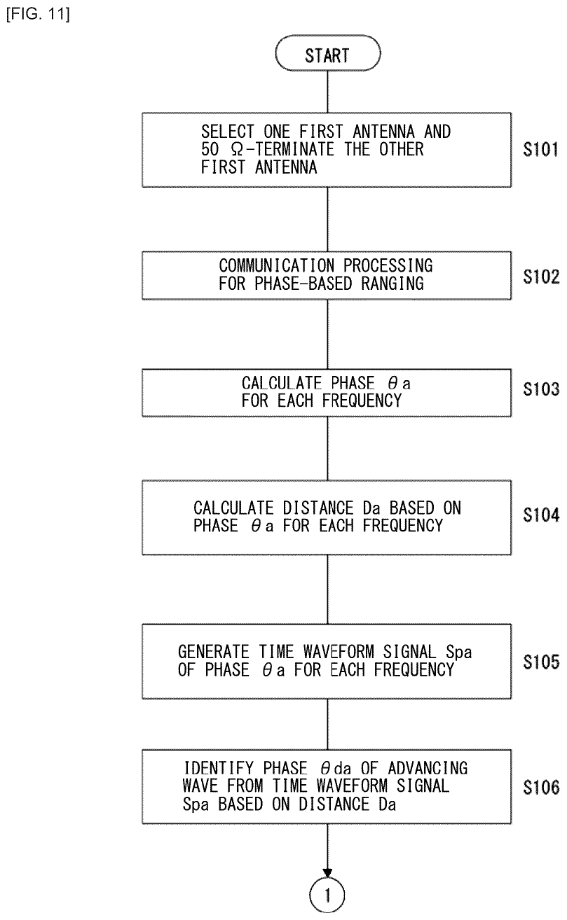

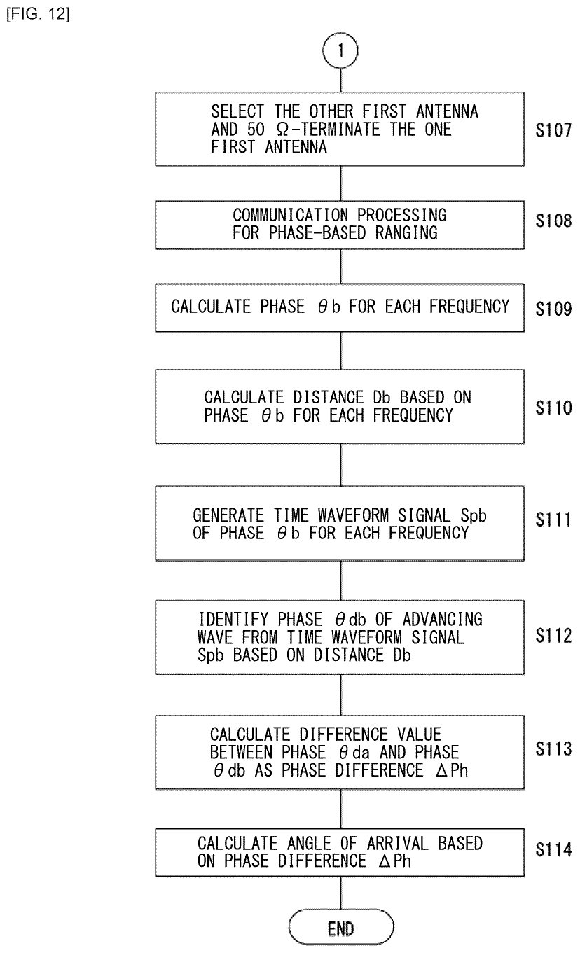

With reference to the flowcharts in FIGS. 11 and 12, description is given of a specific example of a processing procedure to realize the angle detection method according to the first embodiment described above.

In this example, the processing illustrated in FIGS. 11 and 12 is performed by the calculator 31 of the information processing device 1.

In FIG. 11, in step S101, the calculator 31 selects the one first antenna 39-1a and 50Ω-terminates the other first antenna 39-1b. That is, the calculator 31 sets the coupling destination of the first antenna 39-1a to the RF switch 38 by controlling the switch SWa, and sets the coupling destination of the first antenna 39-1b to the resistor Rb by controlling the switch SWb.

In step S102 subsequent to step S101, the calculator 31 performs the processing to realize the communication processing for the phase-based ranging. Specifically, as described above as the processing by the phase-to-frequency characteristic acquirer 31a of the information processing device 1, the calculator 31 performs the processing to acquire the signal phase φa_{IR} and the signal phase φa_{RI} for each frequency, by the communication processing for the phase-based ranging. It is to be noted that the details of the processing have already been described, and redundant description is avoided.

In step S103 subsequent to step S102, the calculator 31 performs the processing to calculate the phase θa for each frequency. That is, the calculator 31 calculates the phase θa for each frequency by adding, for each frequency, the signal phase φa_{IR} and the signal phase φa_{RI} for each frequency acquired by the processing in step S102.

In step S104 subsequent to step S103, the calculator 31 calculates the distance Da based on the phase θa for each frequency. Specifically, as described above, the calculator 31 calculates the distance Da based on the slope of the phase θa.

In step S105 subsequent to step S104, the calculator 31 generates the time waveform signal Spa of the phase θa for each frequency. That is, the calculator 31 assumes the complex transfer function of the amplitude 1 having the phase θa for each frequency as the phase component. The calculator 31 extracts the phase component of the time-axis complex waveform data obtained by performing the inverse Fourier transform on the complex transfer function, to generate the time waveform signal Spa with respect to the phase θa.

In step S106 subsequent to step S105, the calculator 31 identifies the phase θda of the advancing wave from the time waveform signal Spa based on the distance Da.

The calculator 31 performs the processing to identify the phase θda of the advancing wave in step S106, and thereafter, causes the flow to proceed to step S107 illustrated in FIG. 12.

In step S107 illustrated in FIG. 12, the calculator 31 selects the other first antenna 39-1b, and 50Ω-terminates the one first antenna. That is, the calculator 31 sets the coupling destination of the first antenna 39-1b to the RF switch 38 by controlling the switch SWb, and sets the coupling destination of the first antenna 39-1a to the resistor Ra by controlling the switch SWa.

In step S108 subsequent to step S107, the calculator 31 performs the processing to realize the communication processing for the phase-based ranging. Specifically, the calculator 31 performs the processing to acquire the signal phase φb_{IR} and the signal phase φb_{RI} for each frequency, by the communication processing for the phase-based ranging.

It is to be noted that the processing in step S108 is similar to step S102 described above except that the antenna to be used in the communication is assumed to be the first antenna 39-1b, and redundant description is avoided.

In step S109 subsequent to step S108, the calculator 31 calculates the phase θb for each frequency. That is, the calculator 31 calculates the phase θb for each frequency by adding, for each frequency, the signal phase φb_{IR} and the signal phase φb_{RI} for each frequency acquired by the processing in step S108.

In step S110 subsequent to step S109, the calculator 31 calculates the distance Db based on the phase θb for each frequency. Specifically, as described above, the calculator 31 calculates the distance Db based on the slope of the phase θb.

In step S111 subsequent to step S110, the calculator 31 generates the time waveform signal Spb of the phase θb for each frequency. That is, the calculator 31 assumes the complex transfer function of the amplitude 1 having the phase θb for each frequency as the phase component. The calculator 31 extracts the phase component of the time-axis complex waveform data obtained by performing the inverse Fourier transform on the complex transfer function, to generate the time waveform signal Spb with respect to the phase θb.

In step S112 subsequent to step S111, the calculator 31 identifies the phase θdb of the advancing wave from the time waveform signal Spb based on the distance Db.

In step S113 subsequent to step S112, the calculator 31 calculates the difference value between the phase θda and the phase θdb as the phase difference ΔPh. Here, when the phase θda and the phase θdb are identified from the characteristic of the phase (20 described above) for the round-trip of the signal propagation path, the calculator 31 calculates ½ times the difference value between the phase θda and the phase θdb, as the phase difference ΔPh.

Thus, furthermore, in subsequent step S114, the calculator 31 calculates the angle of arrival based on the phase difference ΔPh. That is, the calculator 31 calculates the angle α, that is, the angle of arrival of the radio wave at the first antennae 39-1, by substituting the phase difference ΔPh into “Δφ” in [Expression 3].

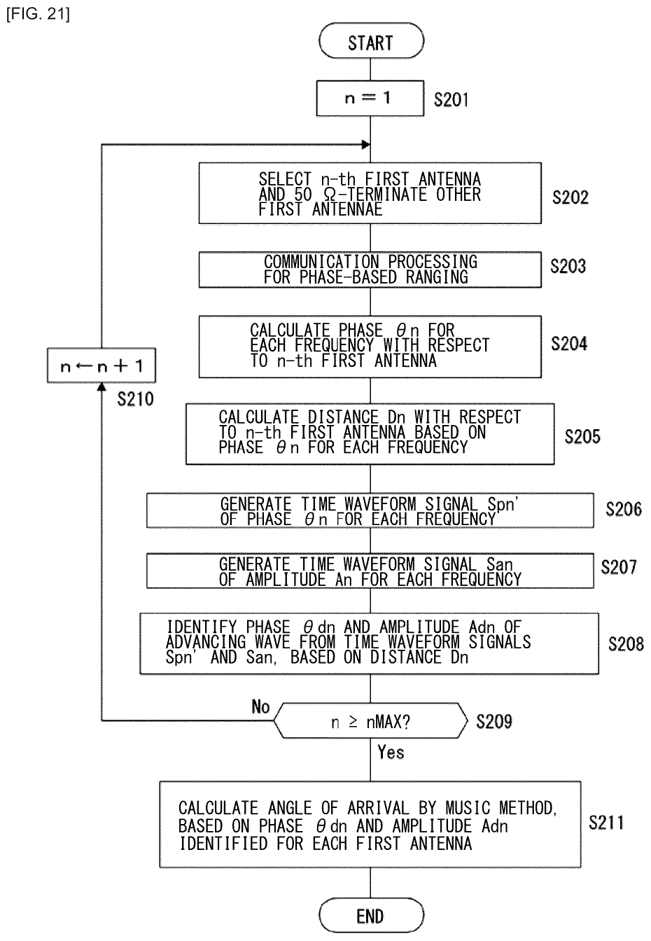

The calculator 31 ends the series of processing illustrated in FIG. 21 now that the processing in step S114 has been performed.

### 1-7. Antenna Spacing and Effects

Here, when detecting the angle of arrival and the angle of departure based on the phase difference in the radio wave at the plurality of the antennae, an issue of a grating lobe should be taken into consideration.

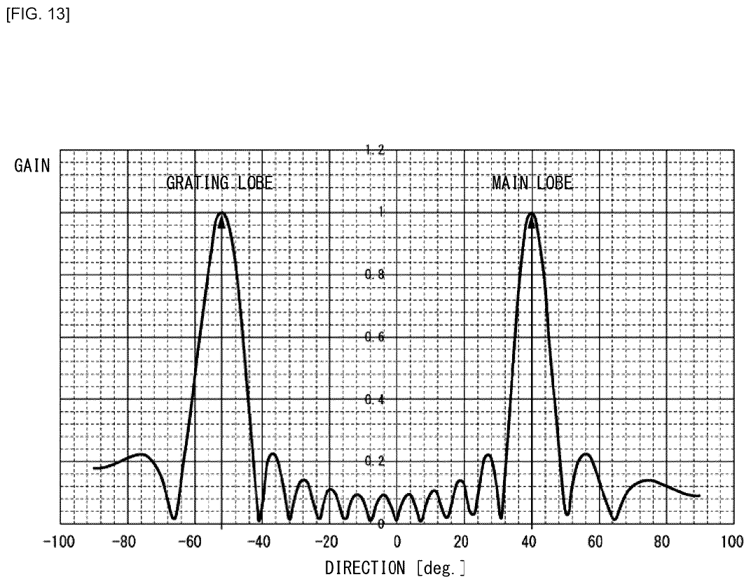

FIG. 13 is an illustrative diagram of the issue of the grating lobe.

The issue of the grating lobe is an issue that when a signal phase difference between the two antennae becomes larger than 180 degrees, two peaks having the same magnitude occur (refer to a main lobe and a grating lobe in the figure), inhibiting accurate estimation of the angle of arrival and the angle of departure.

To address such an issue of the grating lobe, the currently-available method of calculating the angle of arrival and the angle of departure by one-way communication includes setting the antenna spacing to a 0.5 wavelength or less of the carrier wave, to keep the signal phase difference from becoming larger than 180 degrees.

However, when the calculation of the angle of arrival is performed based on the receipt signals obtained by the round-trip communication as in the present embodiment, setting the condition that the antenna spacing is the 0.5 wavelength or less as has been currently-available does not make it possible to address the issue of the grating lobe.

Specifically, in the case of the currently-available one-way communication, a detectable angle αs at which no grating lobes occur is given by the following [Expression 4].

$$[ Mathematical Expression 4 ]$$

$$α s = \{ \begin{matrix}0 , & λ / {d}_{A} < 1 \\ {sin}^{- 1} ( λ / {d}_{A} - 1 ) , & 1 ≦ λ / {d}_{A} < 2 \\ π / 2 , & λ / {d}_{A} ≧ 2\end{matrix} \qquad [ Expression 4 ]$$

It is to be noted that “λ” represents the wavelength of the carrier wave, and “d_{A}” represents the antenna spacing.

Meanwhile, when the round-trip communication is performed as in the present embodiment, the angle αs is represented by the following [Expression 5].

$$[ Mathematical Expression 5 ]$$

$$α s = \{ \begin{matrix}0 , & 0 < λ / {d}_{A} < 2 \\ {sin}^{- 1} ( λ / {d}_{A} - 1 ) , & 2 ≦ λ / {d}_{A} < 4 \\ π / 2 , & λ / {d}_{A} ≧ 4\end{matrix} \qquad [ Expression 5 ]$$

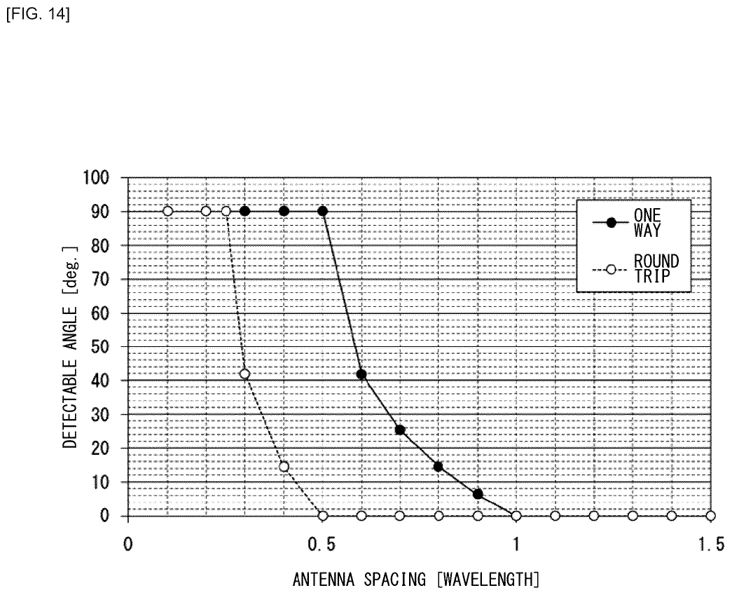

FIG. 14 illustrates the relation between the antenna spacing and the detectable angle with respect to the one-way communication and the round-trip communication, in which the horizontal axis represents the antenna spacing (d_{A}) and the vertical axis represents the detectable angle (αs).

From the forgoing, it can be seen that, when performing the round-trip communication, the antenna spacing d_{A} should be a 0.25 wavelength or less, to make an angle (direction) of ±90 degrees detectable.

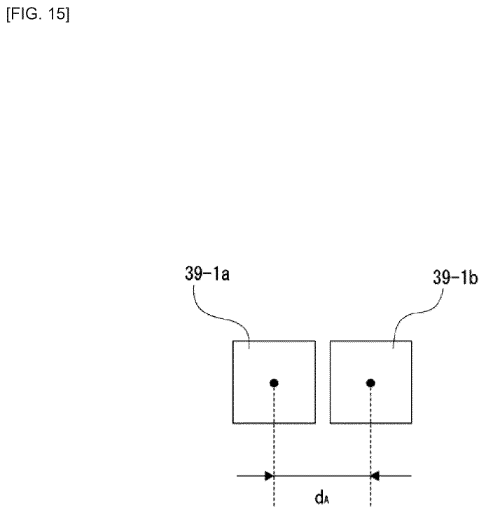

Thus, in the present embodiment, the antenna spacing d_{A} from the first antenna 39-1a to the first antenna 39-1b illustrated in FIG. 15 is the 0.25 wavelength or less of the carrier wave. Specifically, in this example, the antenna spacing d_{A} is about a 0.21 wavelength of the carrier wave.

This makes it possible to address the issue of the grating lobe.

It is to be noted that, for purpose of confirmation, the antenna spacing d_{A} is a spacing between the centers of the two antennae.

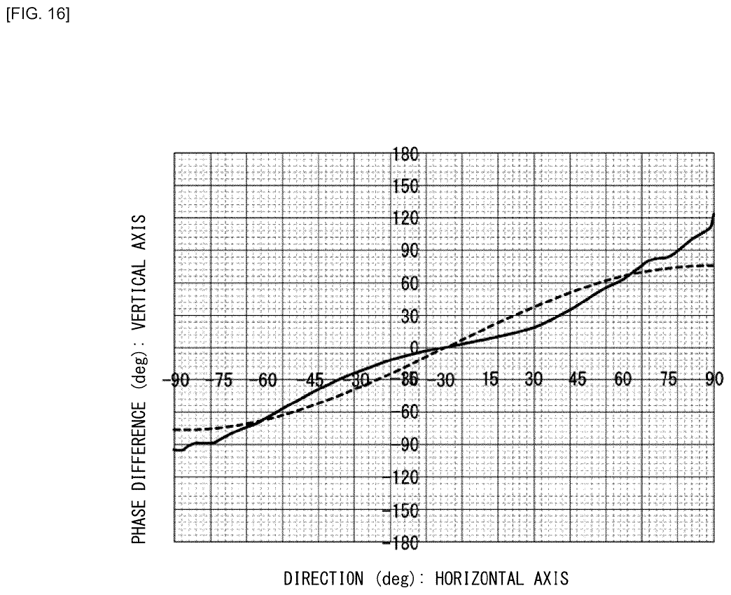

FIG. 16 illustrates a simulation result of a change characteristic of the phase difference when the antenna spacing d_{A} is the 0.21 wavelength of the carrier wave. Specifically, here, FIG. 16 illustrates, as an example, the change characteristic of the phase difference (Δφ) calculated by performing the one-way communication with the second antenna 39-2.

The horizontal axis represents the direction (angle) of the communication device 2 while the vertical axis represents the phase difference. The dotted line in the figure represents a theoretical value, and the solid line represents the simulation result.

As illustrated in the figure, the phase difference in this case does not completely match the theoretical value, but has a monotonically increasing characteristic. It can be understood that the phase difference exhibits high correlation to a change in the direction.

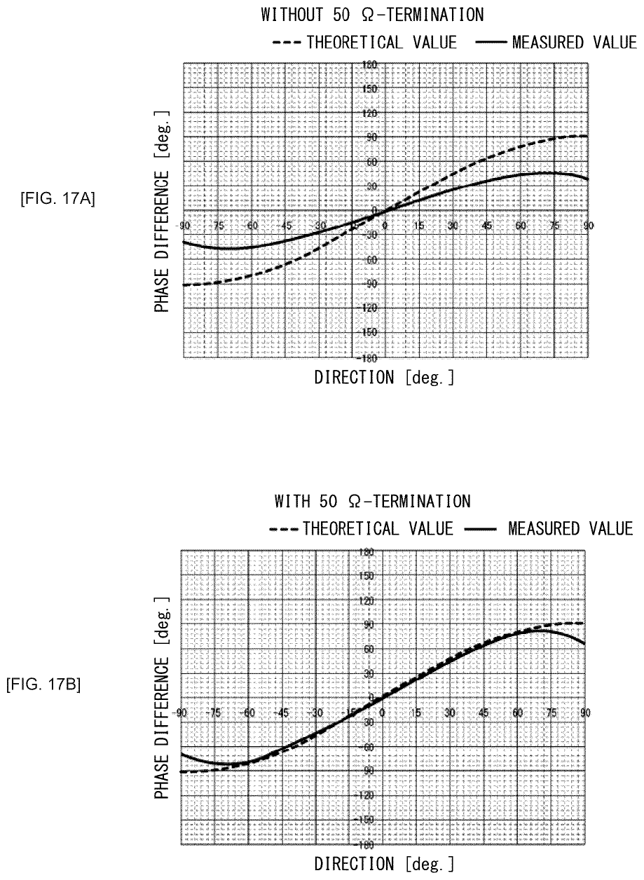

FIG. 17 is an illustrative characteristic diagram related to presence or absence of 50Ω-termination.

Specifically, FIG. 17 illustrates the simulation result of the change characteristic of the phase difference ΔPh when the horizontal axis represents the direction (angle) while the vertical axis represents the phase difference ΔPh. FIG. 17A illustrates the characteristic in the case without the 50Ω-termination described above, while FIG. 17B illustrates the characteristic in the case with the 50Ω-termination. The dotted line indicates the theoretical value and the solid line indicates the simulation result.

In FIG. 17A, in the case without the 50Ω-termination, it can be confirmed that the phase characteristic declines with respect to the theoretical value under the influences of the re-departure.

Meanwhile, in FIG. 17B, in the case with the 50Ω-termination, the change characteristic of the phase difference ΔPh optimally follows a change characteristic of the theoretical value. It can be understood that highly accurate angle detection is possible.

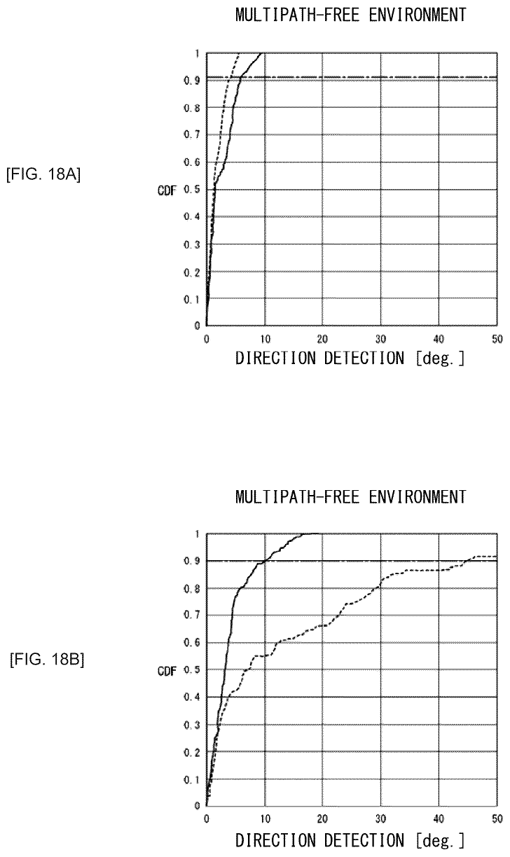

FIG. 18 is a diagram illustrating a performance evaluation result of the angle detection method according to the first embodiment.

FIG. 18A illustrates the performance evaluation result in a multipath-free environment, while FIG. 18B illustrates the performance evaluation result in a multipath-generating environment. The dotted line denotes the performance evaluation result of the currently-available method to obtain the angle of arrival by the one-way communication. The solid line denotes the performance evaluation result of the angle detection method according to the first embodiment. In each figure, the horizontal axis represents a direction detection error, and the vertical axis represents a cumulative distribution function (CDF).

When viewed at 90th percentile, in the multipath-free environment in FIG. 18A, the direction detection error is 6 degrees in the method of the present embodiment, and 4 degrees in the currently-available method. It can be seen that both methods have very small direction detection errors.

Meanwhile, in the multipath-generating environment in FIG. 18B, the direction detection error is 10 degrees in the method of the present embodiment, and 45 degrees in the currently-available method. It can be confirmed that the method of the present embodiment is advantageous in the multipath-generating environment.

It is to be noted that, in the forgoing, an example is given in which the distance D obtained individually by the phase-based ranging is used as the distance Da and the distance Db. However, any one of the distances Da and Db may be used as the distance D to be used in the calculation of the angle of arrival according to the embodiment. In a possible example, whichever of the distances Da and Db has a smaller value may be regarded as the advancing wave and adopted as the distance D.

Moreover, as the distance D, when any one of the information processing device 1 and the communication device 2 includes, for example, a ranging sensor such as a ToF (Time of Flight) sensor or a radar sensor, or a ranging sensor that performs ranging by UWB (Ultra Wide Band) communication, it is conceivable to use a distance to be measured by the relevant ranging sensor (the distance from the information processing device 1 to the communication device 2). The distance D to be used is not necessarily limited to the distance D obtained by the phase-based ranging.

### 2. Second Embodiment

Next, a second embodiment is described.

The second embodiment includes, in the round-trip communication for the phase-based ranging, calculating the angle of arrival using not only the phases but also the amplitudes of the receipt signals obtained for the combination including the first antenna 39-1 and the combination including the second antenna 39-2. Specifically, the second embodiment includes calculating the angle of arrival by a MUSIC (Multiple Signal Classification) method as the calculation of the angle of arrival using the phases and the amplitudes.

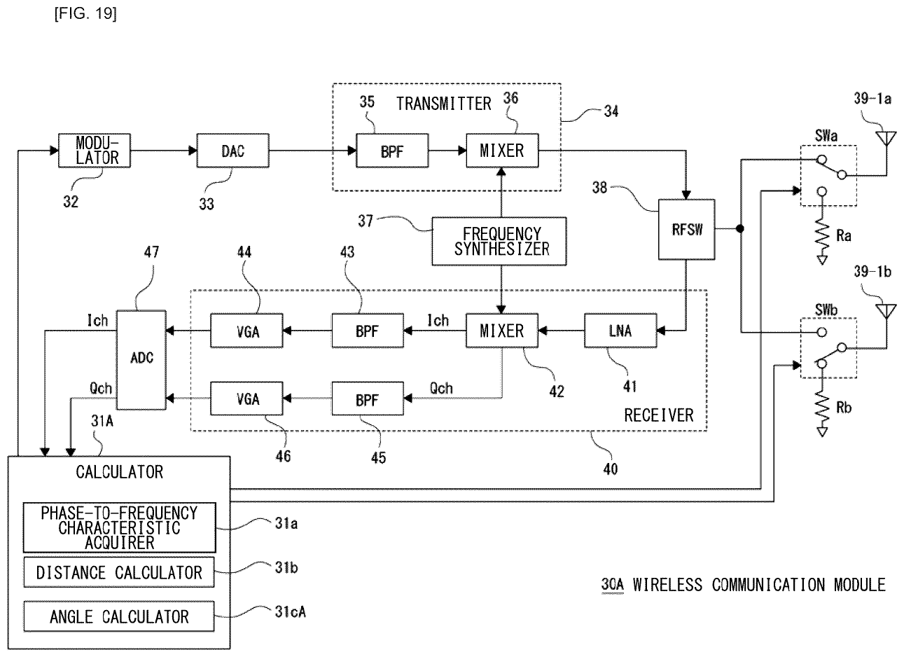

FIG. 19 is a block diagram illustrating an internal configuration example of a wireless communication module 30A included in an information processing device 1 according to the second embodiment.

It is to be noted that the configuration of the information processing device 1 according to the second embodiment is similar to that of the first embodiment except that the wireless communication module 30A is provided instead of the wireless communication module 30, and therefore, redundant description is avoided.

In the following description, the same reference numerals are given to portions that are similar to portions that have already been described, and description thereof is omitted.

As illustrated in the figure, the wireless communication module 30A differs from the wireless communication module 30 illustrated in FIG. 3 in that the wireless communication module 30A includes a calculator 31A instead of the calculator 31.

The calculator 31A differs from the calculator 31 in that the calculator 31A includes an angle calculator 31cA instead of the angle calculator 31c.

The angle calculator 31cA differs from the angle calculator 31c in that the angle calculator 31cA has the forgoing functions of the calculation of the phase θa, the phase θb, the distance Da, and the distance Db, the generation of the time waveform signals Spa and Spb, and the identification of the phases θda and θdb of the advancing wave, and the following additional functions.

That is, a function of acquiring the amplitudes a_{IR} and a_{RI} for each frequency with respect to each of the first antenna 39-1a and the first antenna 39-1b (see [Expression 2] mentioned above); a function of calculating an amplitude A′ for each frequency for each antenna based on the amplitudes a_{IR} and a_{RI} for each frequency for each antenna (a characteristic of the amplitude A² for the round-trip of the signal propagation path, or the characteristic of the amplitude A of the signal propagation path); a function of calculating the time waveform signal Sa of the amplitude A′ for each antenna; a function of identifying the amplitude Ad of the advancing wave from the time waveform signal Sa for each antenna based on the distance D; and a function of calculating the angle of arrival by the MUSIC method based on the amplitude Ad of the advancing wave for each antenna and the phases θda and θdb of the advancing wave.

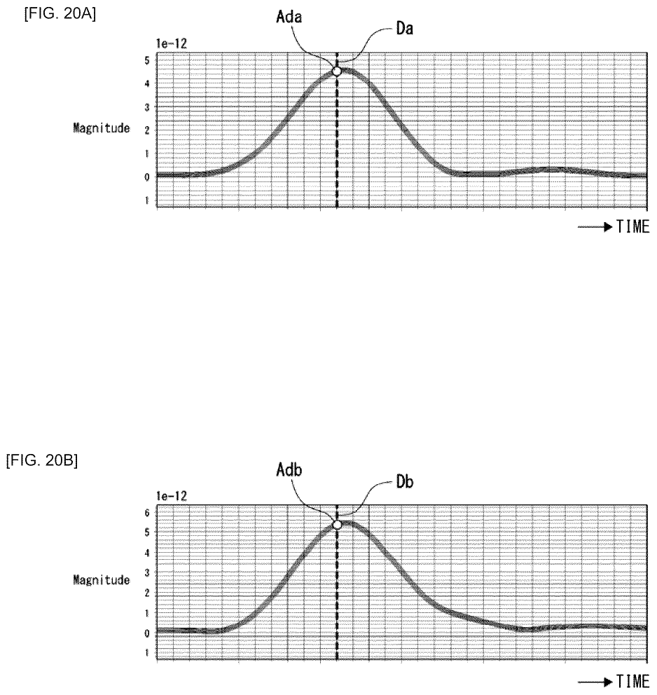

FIG. 20 is an illustrative diagram of a method of identifying the amplitude A′ of the advancing wave from the time waveform signal Sa.

FIG. 20A illustrates the time waveform signal Sa (hereinafter referred to as a “time waveform signal Saa”) obtained by extracting an amplitude component of time-axis complex waveform data Sc (hereinafter referred to as “time-axis complex waveform data Sca”). The time-axis complex waveform data Sca is obtained by performing the inverse Fourier transform on a complex transfer function having the amplitude A′ (hereinafter referred to as an “amplitude Aa”) for each frequency calculated with respect to the first antenna 39-1a as an amplitude component, and having the phase θa as a phase component. FIG. 20B illustrates the time waveform signal Sa (hereinafter referred to as a “time waveform signal Sab”) obtained by extracting an amplitude component of time-axis complex waveform data Sc (hereinafter, referred to as “time-axis complex waveform data Scb”). The time-axis complex waveform data Scb is obtained by performing the inverse Fourier transform on a complex transfer function having the amplitude A′ (hereinafter referred to as an “amplitude Ab”) for each frequency calculated with respect to the first antenna 39-1b as an amplitude component, and having the phase θb as a phase component.

As illustrated in FIG. 20A, the amplitude Ad of the advancing wave (hereinafter referred to as an “amplitude Ada”) is identified from the time waveform signal Saa based on the distance Da.

Moreover, as illustrated in FIG. 20B, the amplitude Ad of the advancing wave (hereinafter referred to as an “amplitude Adb”) is identified from the time waveform signal Sab based on the distance Db.

As described above, the angle calculator 31cA identifies the amplitude Ada of the advancing wave from the time waveform signal Saa and identifies the amplitude Adb of the advancing wave from the time waveform signal Sab. Furthermore, the angle calculator 31cA generates a time waveform signal Spa′ obtained by extracting the phase component of the time-axis complex waveform data Sca, and identifies the phase θda of the advancing wave based on the distance Da from the time waveform signal Spa′. The angle calculator 31cA generates a time waveform signal Spb′ obtained by extracting the phase component of the time-axis complex waveform data Scb, and identifies the phase θdb of the advancing wave based on the distance Db from the time waveform signal Spb′. Moreover, the angle calculator 31cA calculates the angle of arrival by the MUSIC method based on the amplitude Ada and the amplitude Adb, and the phase θda and the phase θdb of the advancing wave.

Here, in the MUSIC method, it is possible to calculate the angle of arrival corresponding to inputs from two or more antennae. Accordingly, it is conceivable to provide three or more first antennae 39-1.

With reference to the flowchart in FIG. 21, description is given of a specific example of a processing procedure to realize the angle detection method as the second embodiment described above.

In this example, the processing illustrated in FIG. 21 is performed by the calculator 31A.

In FIG. 21, in step S201, the calculator 31A sets an antenna identifier n to 1. The antenna identifier n is an identifier to identify the first antenna 39-1 to be used in the round-trip communication for the phase-based ranging.

In step S202 subsequent to step S201, the calculator 31A selects the n-th first antenna 39-1 and 50Ω-terminates the other first antenna 39-1. That is, in this example, the calculator 31A makes a control to set the coupling destination of the n-th first antenna 39-1 to the RF switch 38 by whichever switch SW out of the switches SWa and SWb is provided for the one first antenna 39-1 as the n-th first antenna 39-1, and set the coupling destination of the other first antenna 39-1 to the resistor R by whichever switch SW is provided for the other first antenna 39-1.

It is to be noted that, when the three or more first antennae 39-1 are provided, the set of the switch SW and the resistor R may be provided for each first antenna 39-1, and the calculator 31A may make a control to set the coupling destination of only the n-th first antenna 39-1 to the RF switch 38, and set the coupling destinations of all the other first antennae 39-1 to the resistor R.

In step S203 subsequent to step S202, the calculator 31A performs the processing to realize the communication processing for the phase-based ranging. This processing is similar to the processing in step S102 described above except that the antenna to be used is the n-th first antenna 39-1.

In step S204 subsequent to step S203, the calculator 31A calculates the phase θ′ (referred to as a phase θn) for each frequency with respect to the n-th first antenna 39-1.

In step S205 subsequent to step S204, the calculator 31A calculates the distance D (referred to as the distance Dn) with respect to the n-th first antenna 39-1 based on the phase θn for each frequency.

In step S206 subsequent to step S205, the calculator 31A generates a time waveform signal Sp′ of the phase θn for each frequency (referred to as a time waveform signal Spn′).

Moreover, in step S207 subsequent to step S206, the calculator 31A generates the time waveform signal Sa of an amplitude An for each frequency (referred to as a time waveform signal San).

Furthermore, in step S208 subsequent to step S207, the calculator 31A identifies the phase θd (referred to as a phase θdn) and an amplitude Ad (referred to as an amplitude Adn) of the advancing wave from the time waveform signals Spn′ and San based on the distance Dn.

In step S209 subsequent to step S208, the calculator 31A determines whether or not the antenna identifier n is equal to or larger than an upper limit value nMAX. Here, the upper limit value nMAX is the number of the first antennae 39-1 to be used in the calculation of the angle of arrival. In this example, the upper limit value nMAX is “2.”

In step S209, when it is determined that the antenna identifier n is not equal to or larger than the upper limit value nMAX, the calculator 31A causes the flow to proceed to step S210 to increment the antenna identifier n by 1, and causes the flow to return to step S202.

Thus, the processing to acquire the phase θdn and the amplitude Adn of the advancing wave is performed with respect to the next first antenna 39-1.

Meanwhile, in step S209, when it is determined that the antenna identifier n is equal to or larger than the upper limit value nMAX, the calculator 31A cause the flow to proceed to step S211 to perform the processing to calculate the angle of arrival by the MUSIC method based on the phase θdn and the amplitude Adn identified for each first antenna 39-1.

The calculator 31A ends the series of processing illustrated in FIG. 21 now that the processing in step S211 has been performed.

It is to be noted that, in the forgoing, an example is given in which the calculation of the angle of arrival using both the phase θ′ and the amplitude A′ is performed by the MUSIC method. However, as to the calculation method of the angle of arrival using both the phase θ and the amplitude A, there are many possible alternatives other than the method using the MUSIC method. For example, it is conceivable to calculate the angle of arrival by the linear predictive method, the beamformer method, the Capon method (Capon's beamformer method), the EM (Expectation Maximization) method, the SAGE (Space-Alternating Generalized Expectation-Maximization) method, or the like.

### 3. Modification Examples

It is to be noted that the embodiments are not limited to the specific examples described above, but configurations as various modification examples may be adopted. For example, in the forgoing description, an example is given in which, out of the information processing device 1 and the communication device 2, the information processing device 1 includes the angle calculator (31c or 31cA) according to the embodiment, and the information processing device 1 and the parties concerned include the plurality of the antennae. However, the angle calculator may be included in the communication device 2. Moreover, the communication device 2 and the parties concerned may include the plurality of the antennae.

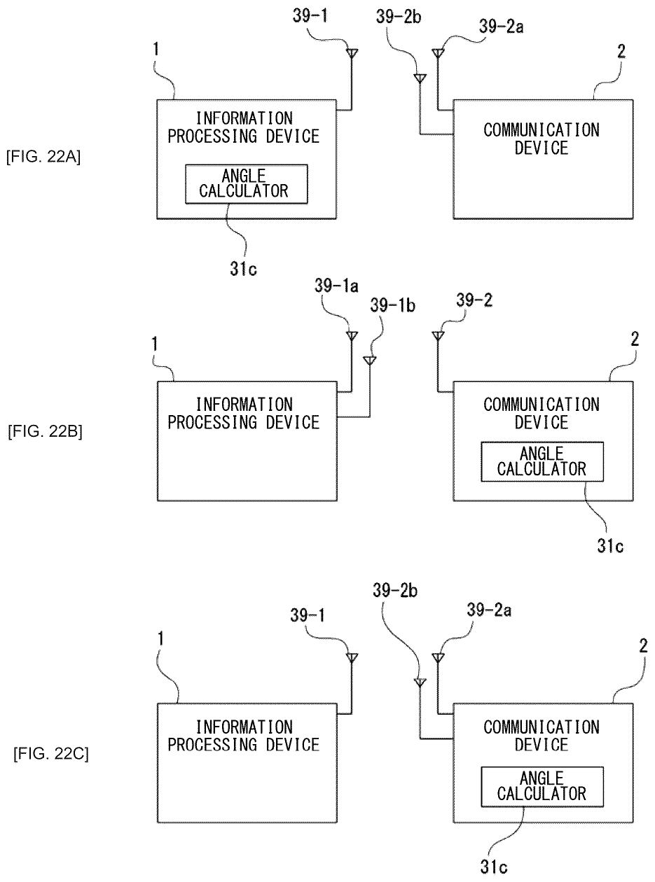

FIG. 22 illustrates specific combination examples as to which device the angle calculator and the plurality of the antennae are to be provided in. It is to be noted that FIG. 22 illustrates an example where the angle calculator 31c is used as the angle calculator of the embodiment, but similar combinations are applicable to the angle calculator 31cA. Moreover, as to the plurality of the antennae, the number of the antennae is not limited to two either.

FIG. 22A illustrates an example where the information processing device 1 includes the angle calculator 31c, and the communication device 2 and the parties concerned include the plurality of the antennae (second antennae 39-2a and 39-2b).

FIG. 22B illustrates an example where the information processing device 1 and the parties concerned include the plurality of the antennae (first antennae 39-1a and 39-1b), and the communication device 2 includes the angle calculator 31c.

FIG. 22C illustrates an example where the communication device 2 and the parties concerned include the plurality of the antennae when the communication device 2 includes the angle calculator 31c as in the example illustrated in FIG. 22B.

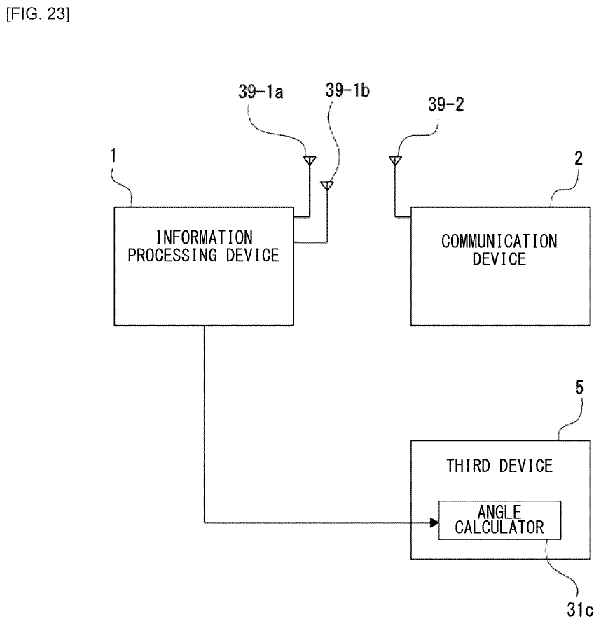

Moreover, in the forgoing description, an example is described in which any one of the devices (the information processing device 1 and the communication device 2) that performs the round-trip communication for the phase-based ranging includes the angle calculator according to the embodiment. However, as illustrated in FIG. 23, the angle calculator according to the embodiment may be included in a device other than the device that performs the round-trip communication for the phase-based ranging.

Specifically, in the example in FIG. 23, a third device 5 different from the information processing device 1 and the communication device 2 includes the angle calculator 31c. The third device 5 may include, for example, a computer device such as a server device configured to perform data communication with the information processing device 1 and the communication device 2.

Here, as in the example in FIG. 23, when the third device 5 includes the angle calculator 31c of the first embodiment, the information processing device 1 (or the communication device 2) transmits the phase θa and the phase θb for each frequency, and the distances Da and Db, to the third device 5. The phase θa and the phase θb for each frequency, and the distances Da and Db are necessary for the calculation of the angle of arrival

When the third device 5 includes the angle calculator 31cA of the second embodiment, the information processing device 1 (or the communication device 2) transmits the phase θa and the phase θb for each frequency, the amplitude Aa and the amplitude Ab for each frequency, and the distances Da and Db, to the third device 5.

It is to be noted that, as to the third device 5, it is also conceivable to transmit the signal phases φa_{IR}, φa_{RI}, φa_{IR}, and φa_{RI} for each frequency obtained by performing the round-trip communication for the phase-based ranging (and amplitudes aa_{IR}, aa_{RI}, ab_{IR}, and ab_{RI} for each frequency when the third device includes the angle calculator 31cA of the second embodiment) to the third device. In this case, the calculation of the phases θa and θb, and the distances Da and Db (including the calculation of the amplitudes Aa and Ab when the third device includes the angle calculator 31cA of the second embodiment) is performed by the third device 5 and parties concerned. It is to be noted that, in this case, the calculation of the distances Da and Db may be made by the information processing device 1 (or the communication device 2) and the parties concerned.

Furthermore, in the forgoing description, an example is given where patch antennae are used as the first antennae 39-1 and the second antenna 39-2. However, as the first antennae 39-1 and the second antenna 39-2, it is conceivable to use dipole antennae, monopole antennae, or modified antennae of monopole antennae such as inverted-F antennae. There are no particular limitations on the form of the antennae.

It is to be noted that, when the dipole antennae, the monopole antennae, or the modified antennae of the monopole antennae described above are used, it is conceivable to dispose a reflection plate to provide directivity in a specific direction.

### 4. Summary of Embodiments

As described above, an angle calculation device according to the embodiment (the information processing device 1, or the communication device 2, or the third device 5) includes an angle calculator (the angle calculator 31c or the angle calculator 31cA) that calculates, based on receipt signals of each of two or more first antennae and a second antenna, an angle of arrival of a radio wave at the first antennae from the second antenna. The first antennae are disposed in a first device at a spacing of a 0.25 wavelength or less of a carrier wave. The second antenna is disposed in a second device different from the first device. The receipt signals are obtained by performing round-trip communication for phase-based ranging between the first antennae and the second antenna.

Thus, adopting a method of calculating the angle of arrival of the radio wave based on the receipt signals obtained by performing the round-trip communication for the phase-based ranging leads to more enhanced angle detection accuracy than the case of calculating the angle of arrival and the angle of departure based on the receipt signal by the one-way communication as has been currently-available. At this occasion, to address the issue of the grating lobe in the case of performing the round-trip communication, the spacing between the two or more first antennae is set to the 0.25 wavelength or less of the carrier wave.

Hence, according to the embodiment, it is possible to attain the enhanced detection accuracy of the angle of arrival of the radio wave.

Moreover, in the angle calculation device according to the embodiment, the angle calculator calculates the angle of arrival based on phases of the receipt signals obtained for respective combinations of the first antennae and the second antenna.

Based on the phases of the receipt signals, it is possible to calculate a phase difference in the receipt signals between the first antennae, making it possible to calculate the angle of arrival of the radio wave at the first antennae from the second antenna by geometric calculation based on the phase difference.

Furthermore, in the angle calculation device according to the embodiment, the angle calculator calculates the angle of arrival based on the receipt signals and distances from the respective first antennae to the second antenna.

Using the distances from the respective the first antennae to the second antenna makes it possible to estimate the advancing wave with respect to the receipt signals for the respective combinations of the first antennae and the second antenna.

Hence, it is possible to attain prevention of erroneous detection of the angle of arrival based on a phase of a delayed wave, and attain the enhanced detection accuracy of the angle of arrival.

In addition, in the angle calculation device according to the embodiment, the angle calculator calculates the distances by performing ranging calculation by a phase-based method based on the receipt signals.

By performing the ranging by the phase-based method leads to attainment of enhanced ranging accuracy in a multipath-generating environment.

Accordingly, even in the multipath-generating environment, it is possible to appropriately identify the phases of the advancing wave based on the distances obtained with high accuracy, and attain the enhanced detection accuracy of the angle of arrival.

Moreover, in obtaining information regarding the distances, it is possible to eliminate the necessity of an additional ranging sensor.

Moreover, in the angle calculation device according to the embodiment, the angle calculator generates, based on the receipt signals, time waveform signals of the phases for the respective combinations of the first antennae and the second antenna, identifies the phases of an advancing wave based on the distances from the respective time waveform signals generated, and calculates the angle of arrival based on the identified phases.

This makes it possible to appropriately estimate the phases of the advancing wave in the multipath-generating environment.

Hence, it is possible to appropriately calculate the angle of arrival even in the multipath-generating environment, and attain the enhanced detection accuracy of the angle of arrival.

Furthermore, in the angle calculation device according to the embodiment, the angle calculator (angle calculator 31cA) calculates the angle of arrival based on the phases and amplitudes of the receipt signals obtained for the respective combinations of the first antennae and the second antenna.

Using not only the phases but also the amplitudes makes it possible to attain the enhanced detection accuracy of the angle of arrival.

In addition, in the angle calculation device according to the embodiment, the angle calculator (angle calculator 31cA) calculates the angle of arrival based on the receipt signals and distances from the respective first antennae to the second antenna.

Using the distances from the respective first antennae to the second antenna makes it possible to estimate the advancing wave with respect to the receipt signals for the respective combinations of the first antennae and the second antenna.

Hence, it is possible to attain prevention of erroneous detection of the angle of arrival based on the phase and the amplitude of the delayed wave, and attain the enhanced detection accuracy of the angle of arrival.

Moreover, in the angle calculation device according to the embodiment, the angle calculator generates, based on the receipt signals, time waveform signals of the phases and time waveform signals of the amplitudes for the respective combinations of the first antennae and the second antenna, identifies the phases and the amplitudes of an advancing wave based on the distances from the respective time waveform signals generated, and calculates the angle of arrival based on the identified phases and the identified amplitudes.

This makes it possible to appropriately estimate the phases and the amplitudes of the advancing wave in the multipath-generating environment.

Accordingly, it is possible to appropriately calculate the angle of arrival even in the multipath-generating environment, and attain the enhanced detection accuracy of the angle of arrival.

Furthermore, in the angle calculation device according to the embodiment, the angle calculator calculates the angle of arrival by the MUSIC method, based on the identified phases and the identified amplitudes.

By the MUSIC method, it is possible to appropriately calculate the angle of arrival.

In addition, in the angle calculation device according to the embodiment, the angle calculator makes a 50Ω-termination control of any first antenna, out of the first antennae, other than whichever first antenna is in use for the round-trip communication for the phase-based ranging.

This makes it possible to attain prevention of phase variations in the receipt signal of the first antenna that is in use, under the influences of the re-departure from the first antenna that is not in use.

Hence, it is possible to prevent the angle of arrival from being calculated based on the erroneous phase information, and attain the enhanced detection accuracy of the angle of arrival.

Moreover, it is conceivable that the angle calculation device according to the embodiment includes each of the first antennae.

Hence, in the device including the first antennae (first device), it is possible to completely go through the round-trip communication for the phase-based ranging and the calculation of the angle of arrival.

Furthermore, in the angle calculation device according to the embodiment, each of the first antennae includes a patch antenna.

It suffices that each of the first antennae is configured to detect the angle of arrival in a range of 90 degrees to −90 degrees. Having no rearward directivity is more advantageous against the multipath.

Accordingly, using the patch antenna as each of the first antennae as described above makes it possible to attain the enhanced detection accuracy of the angle of arrival in the multipath-generating environment.

Furthermore, it is conceivable that the angle calculation device according to the embodiment includes the second antenna.

This makes it possible for the device including the second antenna (second device) to completely go through the round-trip communication for the phase-based ranging and the calculation of the angle of arrival.

In addition, it is conceivable that the angle calculation device according to the embodiment (third device 5) is configured as a different device from the first and second devices. This makes it possible for the third device different from the device that includes the first antennae or the second antenna and performs the round-trip communication for the phase-based ranging, to calculate the angle of arrival based on communication results of the first and second devices.

Moreover, an angle calculation method according to the embodiment is an angle calculation method including calculating, based on receipt signals of each of two or more first antennae and a second antenna, an angle of arrival of a radio wave at the first antennae from the second antenna. The first antennae are disposed in a first device at a spacing of a 0.25 wavelength or less of a carrier wave. The second antenna is disposed in a second device different from the first device. The receipt signals are obtained by performing round-trip communication for phase-based ranging between the first antennae and the second antenna. According to such an angle calculation method as well, it is possible to obtain similar workings and effects to those of the angle calculation device according to the forgoing embodiment.

It is to be noted that the effects described herein are merely illustrative and non-limiting, and there may be other effects.

### 5. Present Technology

It is to be noted that the present technology may also have the following configurations.

(1)

An angle calculation device including
an angle calculator that calculates, based on receipt signals of each of two or more first antennae and a second antenna, an angle of arrival of a radio wave at the first antennae from the second antenna, the first antennae being disposed in a first device at a spacing of a 0.25 wavelength or less of a carrier wave, the second antenna being disposed in a second device different from the first device, and the receipt signals being obtained by performing round-trip communication for phase-based ranging between the first antennae and the second antenna.
   (2)

The angle calculation device according to the forgoing (1), in which
the angle calculator calculates the angle of arrival based on phases of the receipt signals obtained for respective combinations of the first antennae and the second antenna.
   (3)

The angle calculation device according to the forgoing (2), in which
the angle calculator
calculates the angle of arrival based on the receipt signals and distances from the respective first antennae to the second antenna.
   (4)

The angle calculation device according to the forgoing (3), in which
the angle calculator
calculates the distances by performing ranging calculation by a phase-based method based on the receipt signals.
   (5)

The angle calculation device according to the forgoing (4), in which
the angle calculator
generates, based on the receipt signals, time waveform signals of the phases for the respective combinations of the first antennae and the second antenna, identifies the phases of an advancing wave based on the distances from the respective time waveform signals generated, and calculates the angle of arrival based on the identified phases.
   (6)

The angle calculation device according to any one of the forgoing (2) to (4), in which
the angle calculator calculates the angle of arrival based on the phases and amplitudes of the receipt signals obtained for the respective combinations of the first antennae and the second antenna.
   (7)

The angle calculation device according to the forgoing (6), in which
the angle calculator
calculates the angle of arrival based on the receipt signals and distances from the respective first antennae to the second antenna.
   (8)

The angle calculation device according to the forgoing (7), in which
the angle calculator
generates, based on the receipt signals, time waveform signals of the phases and time waveform signals of the amplitudes for the respective combinations of the first antennae and the second antenna, identifies the phases and the amplitudes of an advancing wave based on the distances from the respective time waveform signals generated, and calculates the angle of arrival based on the identified phases and the identified amplitudes.
   (9)

The angle calculation device according to the forgoing (8), in which
the angle calculator
calculates the angle of arrival by an MUSIC method, based on the identified phases and the identified amplitudes.
   (10)

The angle calculation device according to any one of the forgoing (1) to (9), in which
the angle calculator
makes a 50Ω-termination control of any first antenna, out of the first antennae, other than whichever first antenna is in use for the round-trip communication for the phase-based ranging.
   (11)

The angle calculation device according to any one of the forgoing (1) to (10), further including each of the first antennae.

(12)

The angle calculation device according to the forgoing (11), in which
each of the first antennae includes a patch antenna.
   (13)

The angle calculation device according to any one of the forgoing (1) to (10), further including the second antenna.

(14)

The angle calculation device according to any one of the forgoing (1) to (10), in which
the angle calculation device is configured as a different device from the first device and the second device.
   (15)

An angle calculation method including
calculating, based on receipt signals of each of two or more first antennae and a second antenna, an angle of arrival of a radio wave at the first antennae from the second antenna, the first antennae being disposed in a first device at a spacing of a 0.25 wavelength or less of a carrier wave, the second antenna being disposed in a second device different from the first device, and the receipt signals being obtained by performing round-trip communication for phase-based ranging between the first antennae and the second antenna.

### DESCRIPTION OF REFERENCE NUMERALS

1 Information processing device
2, 2A Communication device
11 CPU
12 ROM
13 RAM
20 Communication unit
23 Bus
30, 30A Wireless communication module
31, 31A Calculator
31a Phase-to-frequency characteristic acquirer
31b Distance calculator
31c, 31cA Angle calculator
32 Modulator
33 DAC
34 Transmitter
35 BPF
36 Mixer
37 Frequency synthesizer
38 RF switch
39-1, 39-1a, 39-1b First antenna
39-2 Second antenna
SW, SWa, SWb Switch
R, Ra, Rb Resistor
40 Receiver
41 LNA
42 Mixer
43, 45 BPF
44, 46 VGA
47 ADC
5 Third device

1. An angle calculation device comprising
an angle calculator that calculates, based on receipt signals of each of two or more first antennae and a second antenna, an angle of arrival of a radio wave at the first antennae from the second antenna, the first antennae being disposed in a first device at a spacing of a 0.25 wavelength or less of a carrier wave, the second antenna being disposed in a second device different from the first device, and the receipt signals being obtained by performing round-trip communication for phase-based ranging between the first antennae and the second antenna.

2. The angle calculation device according to claim 1, wherein
the angle calculator calculates the angle of arrival based on phases of the receipt signals obtained for respective combinations of the first antennae and the second antenna.

3. The angle calculation device according to claim 2, wherein
the angle calculator
calculates the angle of arrival based on the receipt signals and distances from the respective first antennae to the second antenna.

4. The angle calculation device according to claim 3, wherein
the angle calculator
calculates the distances by performing ranging calculation by a phase-based method based on the receipt signals.

5. The angle calculation device according to claim 4, wherein
the angle calculator
generates, based on the receipt signals, time waveform signals of the phases for the respective combinations of the first antennae and the second antenna, identifies the phases of an advancing wave based on the distances from the respective time waveform signals generated, and calculates the angle of arrival based on the identified phases.

6. The angle calculation device according to claim 2, wherein
the angle calculator calculates the angle of arrival based on the phases and amplitudes of the receipt signals obtained for the respective combinations of the first antennae and the second antenna.

7. The angle calculation device according to claim 6, wherein
the angle calculator
calculates the angle of arrival based on the receipt signals and distances from the respective first antennae to the second antenna.

8. The angle calculation device according to claim 7, wherein
the angle calculator
generates, based on the receipt signals, time waveform signals of the phases and time waveform signals of the amplitudes for the respective combinations of the first antennae and the second antenna, identifies the phases and the amplitudes of an advancing wave based on the distances from the respective time waveform signals generated, and calculates the angle of arrival based on the identified phases and the identified amplitudes.

9. The angle calculation device according to claim 8, wherein
the angle calculator
calculates the angle of arrival by an MUSIC method, based on the identified phases and the identified amplitudes.

10. The angle calculation device according to claim 1, wherein
the angle calculator
makes a 50Ω-termination control of any first antenna, out of the first antennae, other than whichever first antenna is in use for the round-trip communication for the phase-based ranging.

11. The angle calculation device according to claim 1, further comprising each of the first antennae.

12. The angle calculation device according to claim 11, wherein
each of the first antennae comprises a patch antenna.

13. The angle calculation device according to claim 1, further comprising the second antenna.

14. The angle calculation device according to claim 1, wherein
the angle calculation device is configured as a different device from the first device and the second device.

15. An angle calculation method comprising
calculating, based on receipt signals of each of two or more first antennae and a second antenna, an angle of arrival of a radio wave at the first antennae from the second antenna, the first antennae being disposed in a first device at a spacing of a 0.25 wavelength or less of a carrier wave, the second antenna being disposed in a second device different from the first device, and the receipt signals being obtained by performing round-trip communication for phase-based ranging between the first antennae and the second antenna.
